(19) United States
(12) Patent Application Publication
(10) Pub. No.: US 2023/0399422 A1
(43) Pub. Date: Dec. 14, 2023

(54) ADDITIVE MANUFACTURING POLYELECTROLYTE RESIN AND ADDITIVELY MANUFACTURING

(71) Applicant: Government of the United States of America, as represented by the Secretary of Commerce, Gaithersburg, MD (US)

(72) Inventors: Thomas John Kolibaba, Westminster, CO (US); Jason Philip Killgore, Silverthorne, CO (US)

(21) Appl. No.: 18/206,667

(22) Filed: Jun. 7, 2023

Related U.S. Application Data
(60) Provisional application No. 63/350,265, filed on Jun. 8, 2022.

(51) Int. Cl. C08F 122/02; C08K 5/5397; C08F 2/50

(52) U.S. Cl. CPC C08F 122/02; C08K 5/5397; C08F 2/50; B33Y 10/00

(57) ABSTRACT

An additive manufacturing polyelectrolyte resin for additively manufacturing a additively manufactured article includes: a cationic poly-ammonium electrolyte; an anionic organic acrylate monomer; a chemical modifier selected from the group consisting essentially of a photoabsorber and an ion dispersion solvent comprising an organic reactive diluent; and a photoinitiator.

### CROSS REFERENCE TO RELATED APPLICATIONS

This application claims the benefit of U.S. Provisional Patent Application Ser. No. 63/350,265 (filed Jun. 8, 2022), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is an additive manufacturing polyelectrolyte resin for additively manufacturing a additively manufactured article, the additive manufacturing polyelectrolyte resin comprising: a cationic poly-ammonium electrolyte; an anionic organic acrylate monomer; a chemical modifier selected from the group consisting essentially of a photoabsorber and an ion dispersion solvent comprising an organic reactive diluent; and a photoinitiator.

Disclosed is a process for additively manufacturing an additively manufactured article from an additive manufacturing polyelectrolyte resin, the process comprising: subjecting the additive manufacturing polyelectrolyte resin to a polymerizing light, the additive manufacturing polyelectrolyte resin comprising: a cationic poly-ammonium electrolyte; an anionic organic acrylate monomer; a chemical modifier selected from the group consisting essentially of a photoabsorber and an ion dispersion solvent comprising an organic reactive diluent; and a photoinitiator; polymerizing the anionic organic acrylate monomer in the additive manufacturing polyelectrolyte resin in response to subjecting the additive manufacturing polyelectrolyte resin to the polymerizing light, such that an anionic poly-acrylate electrolyte is formed from the anionic organic acrylate monomer; complexing the cationic poly-ammonium electrolyte with the anionic poly-acrylate electrolyte; and forming a (poly-ammonium)-(poly-acrylate) electrolyte complex in response to complexing the cationic poly-ammonium electrolyte with the anionic poly-acrylate electrolyte, such that the (poly-ammonium)-(poly-acrylate) electrolyte complex comprises the cationic poly-ammonium electrolyte, the anionic poly-acrylate electrolyte, and an ionic linkage between an ammonium group of the cationic poly-ammonium electrolyte and an acrylate group of the anionic poly-acrylate electrolyte to additively manufacture the additively manufactured article from the additive manufacturing polyelectrolyte resin, wherein the additively manufactured article comprises the (poly-ammonium)-(poly-acrylate) electrolyte complex.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, cationic poly-ammonium electrolytes 202.

FIG. 2 shows, according to some embodiments, cationic poly-ammonium electrolytes 202.

FIG. 3 shows, according to some embodiments, anionic organic acrylate monomers 203.

FIG. 4 shows, according to some embodiments, photoinitiators 204.

FIG. 5 shows, according to some embodiments, organic reactive diluents 216.

FIG. 6 shows, according to some embodiments, photoabsorbers 215.

FIG. 7 shows, according to some embodiments, (A) an additive manufacturing polyelectrolyte resin 200 and (B) a (poly-ammonium)-(poly-acrylate) electrolyte complex 206.

FIG. 8 shows, according to some embodiments, resin formulae, working curve parameters, and the concentration of polymerizable alkene groups in each resin.

FIG. 9 shows, according to some embodiments, (a) photo complexation between polyethylenimine and copolymers of methacrylic acid and hydroxyethyl methacrylate and/or dimethylacrylamide. (b) Working curves for the four studied resins, fit parameters can be found in FIG. 8.

FIG. 10 shows, according to some embodiments, (a) thermogravimetric analysis of printed parts from the four studied resins. (b) Comparison of the degradation profile of parts containing reactive diluent compared to the theoretical curve composed of the weighted average of the degradation curves of PEC-I and photopolymerized homopolymers of HEMA and/or DMAAm.

FIG. 11 shows, according to some embodiments, (a) thermogravimetric analysis of thermally cured printed parts from the four studied resins. (b) FTIR of as-printed (solid lines) and thermally cured (dashed lines) PEC parts. The dark blue box highlights the disappearance of the carboxylate stretch while the green box highlights to appearance or intensifying of an amide stretch.

FIG. 12 shows, according to some embodiments, thermal and mechanical analysis of printed parts before and after thermal curing.

FIG. 13 shows, according to some embodiments, dynamic mechanical analysis of printed PEC parts. (a) Normalized storage modulus for as-printed and thermally cured PEC materials. Starting E′ values can be found in FIG. 12. (b) Tan(δ) of as-printed and thermally cured parts.

FIG. 14 shows, according to some embodiments, (a) comparison of printed parts before and after 24 hours of water immersion. Grey background indicates as-printed parts while the red background shows thermally cured parts. (b) Swelling of printed parts after 24 h in water as measured by their mass change. As-printed PEC-D could not be weighed.

FIG. 15 shows, according to some embodiments, (a) optical microscopy of printed rods of PEC-I (i), PEC-H (ii), PEC-D (iii), and PEC-HD (iv). (b) Electron microscopy of a cross-section of the printed rod of PEC-I.

FIG. 16 shows, according to some embodiments, (a) ultraviolet-visible spectroscopy of the four studied resins. (b) Resin spectra focused near the printer wavelength of 405 nm.

FIG. 17 shows, according to some embodiments, thermogravimetric analysis of photopolymerized homopolymers of HEMA and DMAAm.

FIG. 18 shows, according to some embodiments, differential thermograms of parts as printed (solid lines) and after thermal curing (dashed lines). (a) PEC-I, (b) PEC-H, (c) PEC-D, (d) PEC-HD.

FIG. 19 shows, according to some embodiments, FTIR spectra of parts as-printed (solid lines) and after thermal curing (dashed lines). (a) PEC-I, (b) PEC-H, (c) PEC-D, (d) PEC-HD.

FIG. 20 shows, according to some embodiments, differential scanning calorimetry of parts as-printed (solid lines) and after thermal curing (dashed lines). (a) PEC-I, (b) PEC-H, (c) PEC-D, (d) PEC-HD. Green arrow indicates the observed glass transition for PEC-I.

FIG. 21 shows, according to some embodiments, SEM images of cross-sectioned rods of as-printed (a) PEC-I, (b) PEC-H, (c) PEC-D, (d) PEC-HD.

FIG. 22 shows, according to some embodiments, (a) photopolymerization of methacrylic acid yielding a PEI:MAA polyelectrolyte complex. (b) Formation of a network between a branched polymer (red, representing PEI) and separate polymer chains (blue, representing PMAA) that form from individual ionic linkages (blue circles) yielding a network that is associated on the basis of ionic interactions and no covalent crosslinking. (c) PhotoDSC plots of the PEC resins.

FIG. 23 shows, according to some embodiments, PhotoDSC data for 1.25, 2.5, and 5 M resins.

FIG. 24 shows, according to some embodiments, (a) working curves for three concentrations of PEI:MAA resin along with fit parameters of depth of light penetration depth (Dₚ) and critical dose (E_{c}). (b) Plot of tan(δ) vs time for PEI:MAA resins in photo rheology. The purple line indicates the onset of UV exposure (30 s after data acquisition begins). The green arrows in each panel indicate the dose used for printing. (c) Plot of storage modulus vs time for PEI:MAA resins in photo rheology.

FIG. 25 shows, according to some embodiments, (a) photos of the as-printed 5 M PEC boats on the left and thermally crosslinked boats on the right. (b) Optical microscope images of a gyroid lattice printed from the 5 M PEC without thermal curing (i, iii) and after thermal curing (ii, iv). Insets show photographs of full cylindrical lattices, programmed diameter=13 mm, programmed height=25 mm. White scale bars represent 1 mm, blue scale bars represent 100 mm. (c) Time lapse photographs of the as-printed and thermally crosslinked boats exposed to water.

FIG. 26 shows, according to some embodiments, (a) photos of the as-printed PEGDA-PEC boat. (b) Time lapse photographs of as-printed (left) and thermally-cured (right) PEGDA-PEC parts. (c) Increase in volume of printed cylindrical compression test specimens when exposed to water as a function of PEGDA content and thermal cure. Asterisk denotes a measurement based off a single specimen. (d) Compressive stress-strain curve of dry 5 M PEC and PEGDA-PEC parts. (e) Compressive stress-strain curve of hydrated 5 M PEC and PEGDA parts.

FIG. 27 shows, according to some embodiments, (a) upcycling and reprinting of an additively manufactured polyelectrolyte complex. First, a printed PEC part (first photograph) is dissolved in base (second photograph), which is then incorporated into virgin resin and reprinted into a new part (final photograph). Schematic illustrations of the chemical transformations throughout this process are shown in the insets. (b) Ambient condition compressive stress-strain plot comparing a representative upcycled PEC and the as-printed 5 M PEC from virgin resin. (c) Compressive stress-strain plots of samples after equilibration in DI water.

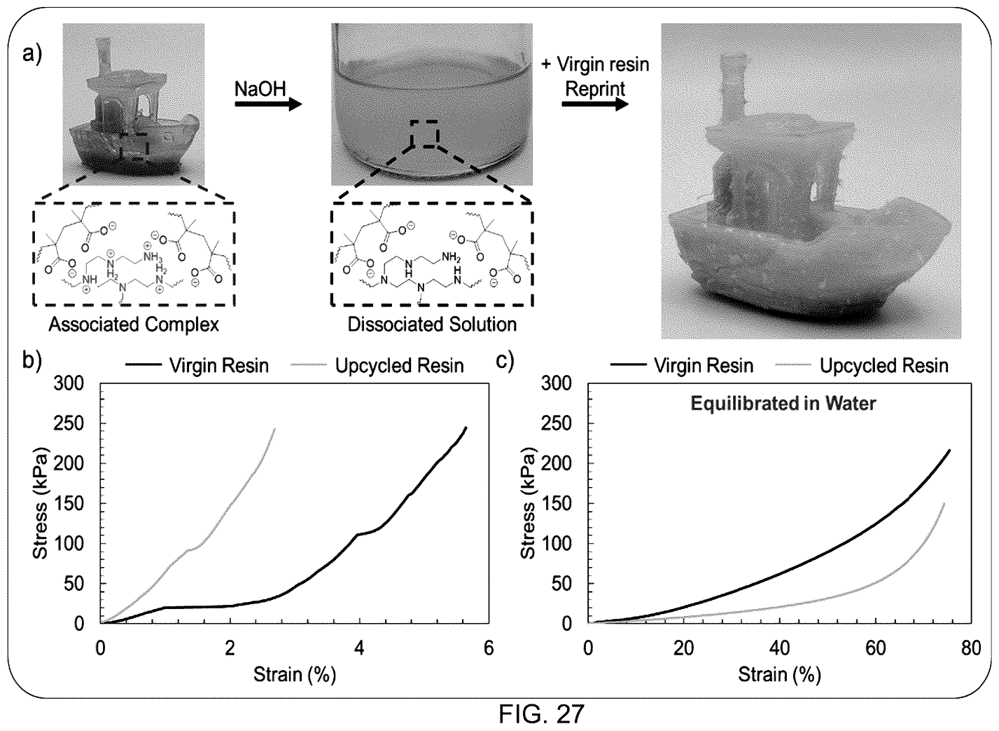

FIG. 28 shows, according to some embodiments, a cycle among components in recycling materials of additive manufacturing polyelectrolyte resin 200 and additively manufactured article 201.

FIG. 29 shows, according to some embodiments, working curve and corresponding fits for the 5 M Resin (blue) and the PEGDA Resin (green).

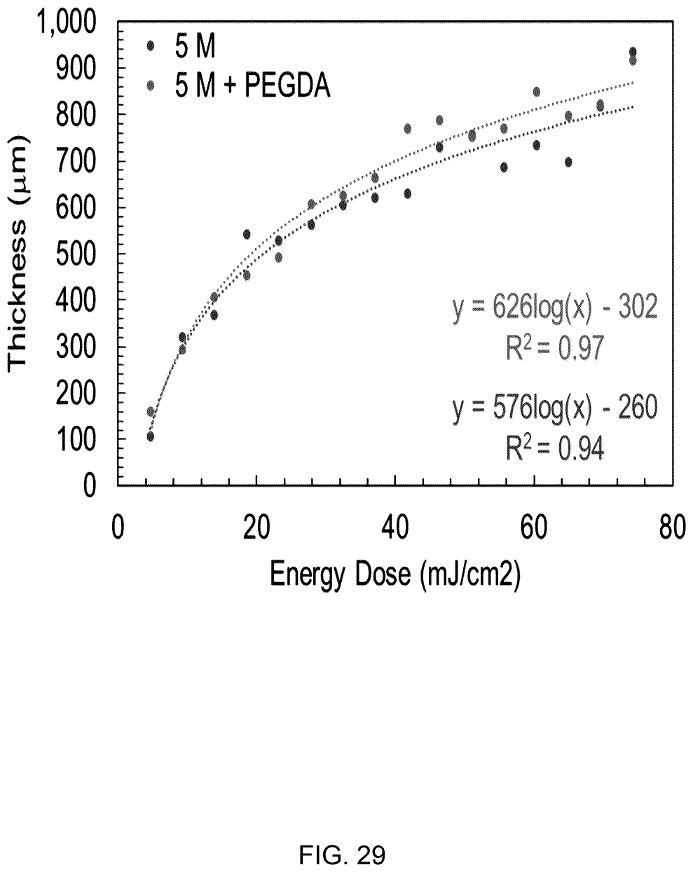

FIG. 30 shows, according to some embodiments, modulus values for the first 10% (low-stress) and final 10% (max-stress) of applied force in DMA compression testing.

FIG. 31 shows, according to some embodiments, CAD model used for projection of the working curve. Each block measures 1×1 mm² at the base.

### DETAILED DESCRIPTION

A detailed description of one or more embodiments is presented herein by way of exemplification and not limitation.

Polyelectrolyte complexes are networks of polycations and polyanions that are held together by ionic bonds. They have a variety of useful properties, including biocompatibility, biodegradability, drug delivery, and flame retardance. However, their ionic bonds make them incompatible with conventional melt processing techniques, which has limited their commercial use to coatings and films.

It has been discovered that additive manufacturing polyelectrolyte resin 200 and additively manufacturing an additively manufactured article 201 from additive manufacturing polyelectrolyte resin 200 provide polyelectrolyte complexes that can be used in a wider variety of applications than conventional printable compositions used in printing by extrusion or melt processing. The new types of polyelectrolyte complexes have been designed to be more compatible with conventional processing techniques, including three dimensional printing or vat polymerization.

Advantageously, additive manufacturing polyelectrolyte resin 200 and additively manufacturing therefrom can be used to make an additively manufactured article 201 that includes, e.g., novel medical implants, flame-retardant articles, batteries, and the like. It is contemplated that additive manufacturing polyelectrolyte resin 200 is a liquid that can be printed (via vat photopolymerization, stereolithography, and the like) or spin coated (on a substrate to make thin films) as additively manufactured article 201.

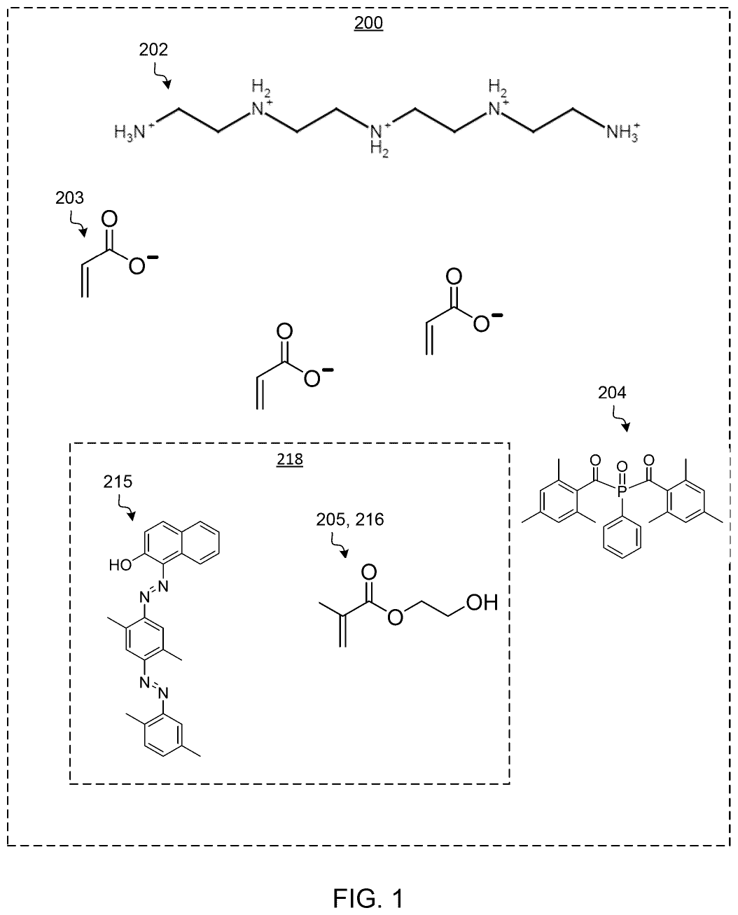

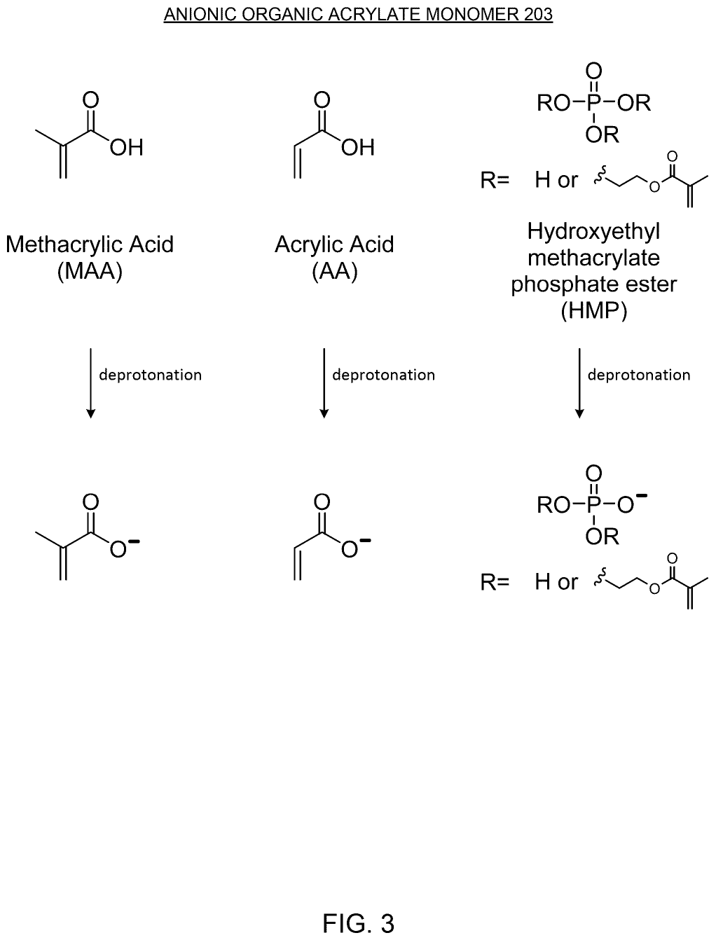

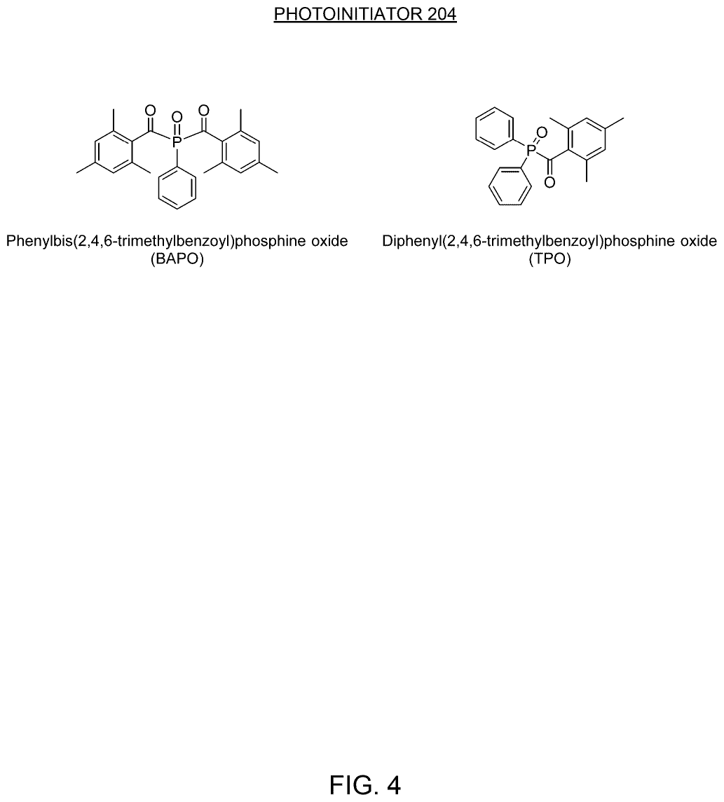

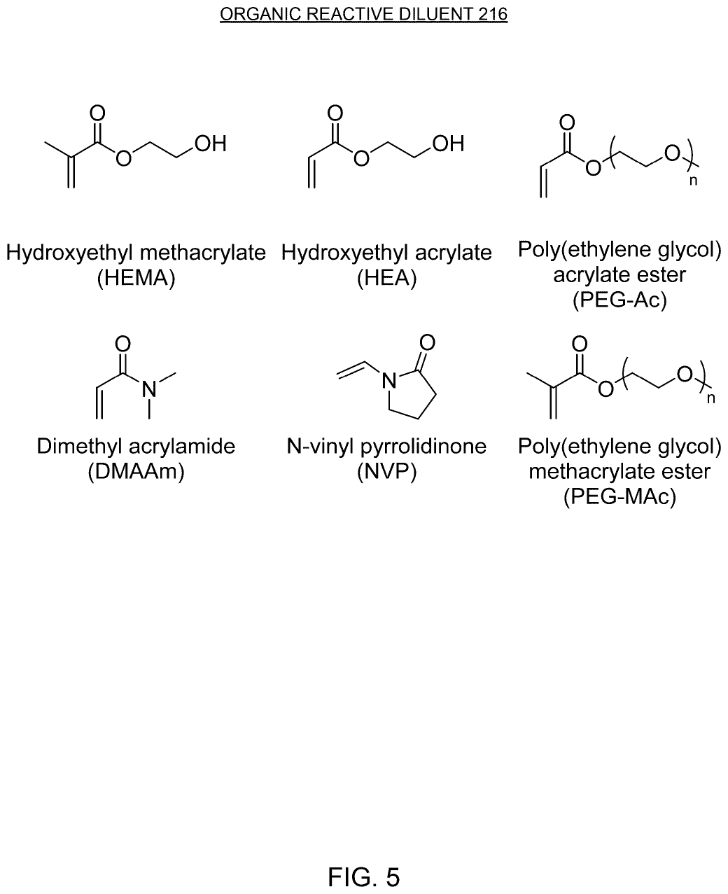

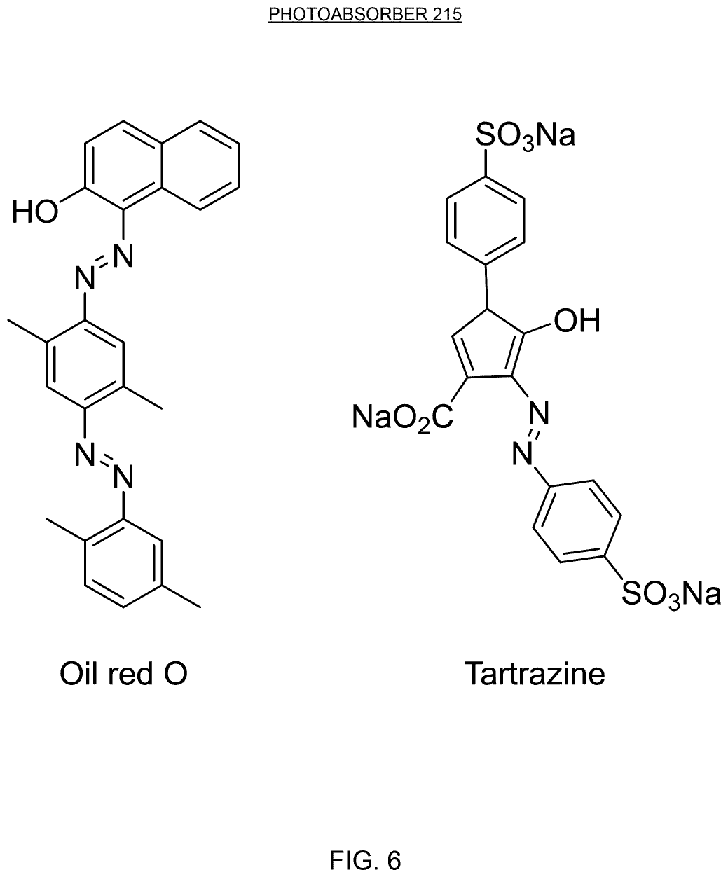

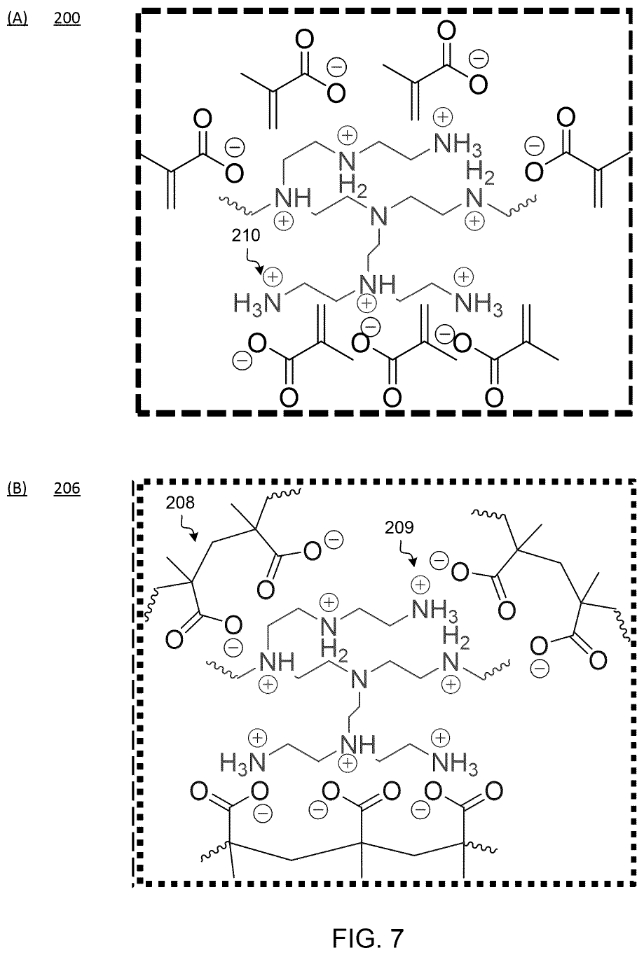

In an embodiment, with reference to FIG. 1, FIG. 3, FIG. 4, FIG. 5, FIG. 6, and FIG. 7, additive manufacturing polyelectrolyte resin 200 for additively manufacturing an additively manufactured article 201 includes: cationic poly-ammonium electrolyte 202; anionic organic acrylate monomer 203; chemical modifier 218 selected from the group consisting essentially of photoabsorber 215 and ion dispersion solvent 205 including organic reactive diluent 216; and photoinitiator 204. In an embodiment, additive manufacturing polyelectrolyte resin 200 also includes covalent crosslinker 207. In an embodiment, chemical modifier 218 is photoabsorber 215. In an embodiment, chemical modifier 218 is ion dispersion solvent 205. In an embodiment, chemical modifier 218 is photoabsorber 215 and ion dispersion solvent 205.

In an embodiment, additively manufactured article 201 includes (poly-ammonium)-(poly-acrylate) electrolyte complex 206 that includes: cationic poly-ammonium electrolyte 202; and anionic poly-acrylate electrolyte 208 in electrostatic communication with cationic poly-ammonium electrolyte 202 via ionic linkage 209.

In an embodiment, additively manufactured article 201 includes (poly-ammonium)-(poly-acrylate) electrolyte complex 206 including: cationic poly-ammonium electrolyte 202; anionic poly-acrylate electrolyte 208 in electrostatic communication with cationic poly-ammonium electrolyte 202 via ionic linkage 209; and a crosslinked reaction product of (poly-ammonium)-(poly-acrylate) electrolyte complex 206. In an embodiment, a crosslinked reaction product of (poly-ammonium)-(poly-acrylate) electrolyte complex 206 is amide crosslinked polymer 213.

In an embodiment, additively manufactured article 201 includes a crosslinked reaction product of (poly-ammonium)-(poly-acrylate) electrolyte complex 206. In an embodiment, a crosslinked reaction product of (poly-ammonium)-(poly-acrylate) electrolyte complex 206 is amide crosslinked polymer 213.

Additively manufactured article 201 can be made of various elements and components that are print-fabricated, e.g.: via polymerization of anionic organic acrylate monomer 203 and formation of (poly-ammonium)-(poly-acrylate) electrolyte complex 206 between cationic poly-ammonium electrolyte 202 and anionic poly-acrylate electrolyte 208; or via crosslinking of (poly-ammonium)-(poly-acrylate) electrolyte complex 206 to form amide crosslinked polymer 213.

Additively manufactured article 201 can be various sizes or shapes. A smallest dimension of additively manufactured article 201 can be based on a spatial dimension resolution of laser light 219 that forms anionic poly-acrylate electrolyte 208 from anionic organic acrylate monomer 203 with subsequent formation of (poly-ammonium)-(poly-acrylate) electrolyte complex 206 in a solid phase. It is contemplated that multiple pieces of additively manufactured article 201 can be attached together to form a larger structure. Given an arbitrarily sized vat for forming (poly-ammonium)-(poly-acrylate) electrolyte complex 206 or additively manufactured article 201, an arbitrary sized additively manufactured article 201 can be made.

While additively manufactured article 201 is a solid material, additive manufacturing polyelectrolyte resin 200 is a liquid, wherein additively manufactured article 201 is insoluble in additive manufacturing polyelectrolyte resin 200.

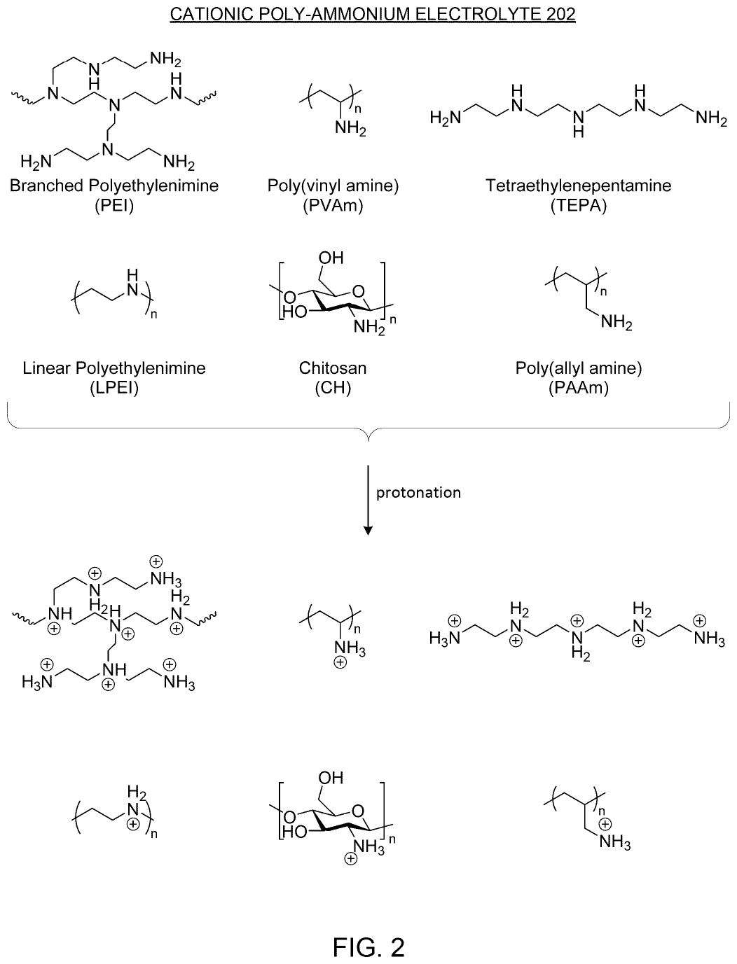

In an embodiment, with reference to FIG. 2, cationic poly-ammonium electrolyte 202 includes a primary ammonium group, a secondary ammonium group, a tertiary ammonium group, a quaternary ammonium group, or a combination comprising at least one of the foregoing ammonium groups. Exemplary cationic poly-ammonium electrolytes 202 are shown in FIG. 1. It is contemplated that cationic poly-ammonium electrolyte 202 is straight chain or branched, wherein the various ammonium groups are terminal groups, backbone groups, or a combination of terminal groups and backbone groups. The ammonium group can be part of a ring structure. The backbone or branch of cationic poly-ammonium electrolyte 202 can include carbon (e.g., in saturated hydrocarbon groups such as methylene groups, ethylene groups, and the like or in unsaturated groups) or heteroatoms (e.g., O, P, S, and the like) that separate ammonium groups. It is contemplated that the ammonium group can be produced from an amine group by protonation of the amine group, wherein the amine group can include a nitrogen atom with 0 to 3 hydrogen atoms attached to it in the ammonium form. A polymethylene chain that includes a chain of carbon atoms can interconnect and atomincally space apart neighboring amine groups. An R group (a variable group that can be various moieties such as an alkyl group, an aryl group, or a functional group) can be attached to the N atom of the ammonium group. The number of amine groups and the length of the polymethylene chain can vary depending on the specific polyamine. The R group can also vary and can modify the properties of cationic poly-ammonium electrolyte 202. In an embodiment, cationic poly-ammonium electrolyte 202 is present in additive manufacturing polyelectrolyte resin 200 in an amount from 0.001 wt % to 50 wt %, specifically from 0.1 wt % to 50 wt %, and more specifically from 0.1 wt % to 30 wt %, based on the weight of additive manufacturing polyelectrolyte resin 200. In an embodiment, cationic poly-ammonium electrolyte 202 is polyethylenimine (PEI). In an embodiment, PEI is present in additive manufacturing polyelectrolyte resin 200 in an amount from 17 wt % to 21.5 wt %, based on the weight of additive manufacturing polyelectrolyte resin 200. In an embodiment, cationic poly-ammonium electrolyte 202 is poly(vinyl amine), tetraethylene pentamine (TEPA), linear polyethylenimine (LPEI), chitosan (CH), or poly(allyl amine) (PAAm) that is present in an amount from 1 wt % to 30 wt %, based on the weight of additive manufacturing polyelectrolyte resin 200. Cationic poly-ammonium electrolyte 202 can have a weight-average molecular weight of 100 g/mol to 1,000,000 g/mol, or 100 g/mol to 5,000 g/mol, or less than or equal to 1,000,000 g/mol and greater than or equal to 100 g/mol and less than, equal to, or greater than 200 g/mol, 300, 400, 500, 600, 700, 800, 900, 1,000, 1,200, 1,400, 1,600, 1,800, 2,000, 2,500, 3,000, 4,000, 5,000, 6,000, 8,000, 10,000, 15,000, 20,000, 25,000, 30,000, 40,000, 50,000, 60,000, 80,000, 100,000, 150,000, 200,000, 250,000, 500,000, or 750,000 g/mol.

Additive manufacturing polyelectrolyte resin 200 includes anionic organic acrylate monomer 203. In an embodiment, with reference to FIG. 3, anionic organic acrylate monomer 203 includes an acrylate group directly attached to a carbon atom or a hydrogen atom as:

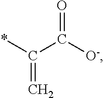

wherein * is a point of attachment for the hydrogen atom or the carbon atom to the acrylate group. “Acrylate” includes a compound having a —C═C—C(═O)O— core structure with atoms having their valence filled with appropriate atoms or functional groups from which an acrylate anion can be formed, e.g., by deprotonation of a hydroxy (—OH) group. Accordingly acrylates are starting compounds of anionic organic acrylate monomer 203. Examples of such acrylates include acrylic acid, methacrylic acid, derivatives thereof, salts thereof, or a combination thereof. Further included are acrylate or methacrylate esters of di, tri, tetra hydroxy compounds, divinyl or diallyl compounds separated by an azo group such as the vinyl or allyl esters of di or tri functional acids, and combinations thereof. Examples of the acrylates include 1,4-butanediol diacrylate, 1,4-butanediol dimethacrylate, 1,3-butylene glycol diacrylate, 1,3-butylene glycol dimethacrylate, diethylene glycol diacrylate, diethylene glycol dimethacrylate, ethylene glycol diacrylate, ethylene glycol dimethacrylate, ethoxylated bisphenol A diacrylate, ethoxylated bisphenol A dimethacrylate, 1,6-hexanediol diacrylate, 1,6-hexanediol dimethacrylate, neopentyl glycol dimethacrylate, polyethylene glycol diacrylate, polyethylene glycol dimethacrylate, triethylene glycol diacrylate, triethylene glycol dimethacrylate, tripropylene glycol diacrylate, tetraethylene glycol diacrylate, tetraethylene glycol dimethacrylate, dipentaerythritol pentaacrylate, pentaerythritol tetraacrylate, pentaerythritol triacrylate, ethoxylated trimethylol triacrylate, ethoxylated pentaerythritol tetracrylate, trimethylolpropane triacrylate, trimethylolpropane trimethacrylate, cyclopentadiene diacrylate, tris(2-hydroxyethyl) isocyanurate triacrylate, and tris(2-hydroxyethyl) isocyanurate trimethacrylate. Various other acrylates can be used including a phosphoric acid methacrylate ester, wherein the phosphoric acid methacrylate ester can be monofunctional (e.g., include one acrylate group per molecule) or multifunctional (e.g., include more than one acrylate group per molecule) such as difunctional (i.e., include two acrylate groups per molecule). Exemplary phosphoric acid methacrylate esters include phosphoric acid 2-hydroxyethyl methacrylate ester (HMP), bis[2-(methacryloyloxy)ethyl] phosphate, and the like. In an embodiment, anionic organic acrylate monomer 203 is the phosphoric acid methacrylate ester. In an embodiment, the phosphoric acid methacrylate ester is phosphoric acid 2-hydroxyethyl methacrylate ester (HMP). Additive manufacturing polyelectrolyte resin 200 can have any suitable weight ratio of cationic poly-ammonium electrolyte 202 to anionic organic acrylate monomer 203, such as 1:1 to 1:10, 1:2 to 1:4, or greater than or equal to 1:10 and less than or equal to 1:1 and less than, equal to, or greater than 1:1.5, 1:2, 1:2.5, 1:3, 1:3.5, 1:4, 1:5, 1:6, 1:7, 1:8, or 1:9. In an embodiment, anionic organic acrylate monomer 203 is present in additive manufacturing polyelectrolyte resin 200 in an amount from 0.001 wt % to 75 wt %, specifically from 0.1 wt % to 75 wt %, and more specifically from 0.1 wt % to 50 wt %, based on the weight of additive manufacturing polyelectrolyte resin 200. In an embodiment, anionic organic acrylate monomer 203 is methacrylic acid (MAA). In an embodiment, MAA is present in additive manufacturing polyelectrolyte resin 200 in an amount from 34 wt % to 43 wt %, based on the weight of additive manufacturing polyelectrolyte resin 200. In an embodiment, MAA is present in a 1:1 stoichiometry with cationic poly-ammonium electrolyte 202. In an embodiment, anionic organic acrylate monomer 203 is acrylic acid (AA) or hydroxyethyl methacrylate phosphate esters (HMPs) that are present in an amount from 3 wt % to 70 wt %, based on the weight of additive manufacturing polyelectrolyte resin 200.

Additive manufacturing polyelectrolyte resin 200 includes photoinitiator 204. In an embodiment, with reference to FIG. 4, photoinitiator 204 includes a phosphine oxide photoinitiator. The phosphine oxide photoinitiator can have a functional wavelength range, e.g., from 370 nanometers (nm) to 1200 nm, specifically form 370 nm to 450 nm (e.g., monoacyl and bisacyl phosphine oxides). Exemplary phosphine oxides include monoacylphosphine oxides, e.g., (2,4,6-trimethylbenzoyl)-diphenyl-phosphine oxide or phenyl-(2,4,6-trimethylbenzoyl)-phosphinic acid ethyl ester; bisacylphosphine oxides, e.g., bis(2,6-dimethoxybenzoyl)-(2,4,4-trimethyl-pent-1-yl) phosphine oxide, bis(2,4,6-trimethylbenzoyl)-phenyl-phosphine oxide, bis(2,4,6-trimethylbenzoyl)-(2,4-dipentoxyphenyl)phosphine oxide; and trisacylphosphine oxides. In an embodiment, photoinitiator 204 is BAPO or TPO.

Commercially available phosphine oxide photoinitiators that provide photoinitiation when irradiated at a wavelength from 380 nm to 450 nm include bis(2,4,6-trimethylbenzoyl)phenyl phosphine oxide (IRGACURE 819, BASF Corp., Tarrytown, N.Y.), bis(2,6-dimethoxybenzoyl)-(2,4,4-trimethylpentyl) phosphine oxide (CGI 403, BASF Corp.), bis(2,6-dimethoxybenzoyl)-2,4,4-trimethylpentyl phosphine oxide (in a 25:75 mixture by weight with 2-hydroxy-2-methyl-1-phenylpropan-1-one, available as IRGACURE 1700, BASF Corp.), bis(2,4,6-trimethylbenzoyl)phenyl phosphine oxide (in a 1:1 mixture by weight with 2-hydroxy-2-methyl-1-phenylpropane-1-one, available as DAROCUR 4265, BASF Corp.), and ethyl 2,4,6-trimethylbenzylphenyl phosphinate (LUCIRIN LR8893X, BASF Corp.). Other suitable commercially available phosphine oxide photoinitiators include those available under the trade designations IRGACURE 379 (2-Dimethylamino-2-(4-methyl-benzyl)-1-(4-morpholin-4-yl-phenyl)-butan-1-one), IRGACURE 2100 (which includes as one of the components IRGACURE 819, which is phenylbis(2,4,6-trimethylbenzoyl)-phosphine oxide), LUCIRIN TPO (2,4,6-trimethylbenzoyldiphenylphosphine oxide), LUCIRIN TPO-L (ethyl-2,4,6-trimethylbenzoylphenylphosphinate), and LUCIRIN TPO-XL (which includes phenyl-bis(2,4,6-trimethylbenzoyl) phosphine oxide), which are all available from BASF Corp.

In an embodiment, photoinitiator 204 is present in additive manufacturing polyelectrolyte resin 200 in an amount from 0.001 wt % to 10 wt %, specifically from 0.1 wt % to 10 wt %, and more specifically from 0.1 wt % to 5 wt %, based on the weight of additive manufacturing polyelectrolyte resin 200. In an embodiment, photoinitiator 204 is TPO or BPO that is present in additive manufacturing polyelectrolyte resin 200 in an amount from 1 wt % to 3 wt % (e.g., 2 wt %), based on the weight of additive manufacturing polyelectrolyte resin 200. In an embodiment, photoinitiator 204 is 2-hydroxy-2-methylpropiophenone, 2-hydroxy-4′-(2-hydroxyethoxy)-2-methylpropiophenone, lithium phenyl-2,4,6-trimethylbenzoylphosphinate (Li-TPO), ethyl phenyl(2,4,6-trimethylbenzoyl)phosphinate (TPO-L), camphorquinone, or a combination thereof that is present in an amount from 0.1 wt % to 4 wt %, based on the weight of additive manufacturing polyelectrolyte resin 200.

Additive manufacturing polyelectrolyte resin 200 can include an optional secondary photoinitiators, e.g., to broaden the range of wavelengths of radiation absorbed by additive manufacturing polyelectrolyte resin 200. Examples of secondary photoinitiators include α-aminoketones, α-hydroxyketones, phenylglyoxalates, thioxanthones, benzophenones, benzoin ethers, oxime esters, amine synergists, and combinations thereof. For example, photoinitiators can include α-hydroxycycloalkyl phenyl ketones or dialkoxyacetophenones; α-hydroxy- or α-amino-acetophenones, for example, oligo-[2-hydroxy-2-methyl-1-[4-(1-methylvinyl)-phenyl]-propanone], 2-hydroxy-2-methyl-1-phenyl-propanone, 2-hydroxy-1-[4-(2-hydroxy-ethoxy)-phenyl]-2-methyl-propan-1-one, 2-methyl-1-[4-(methylthio)phenyl]-2-(4-morpholinyl)-propan-1-one, 2-dimethylamino-2-(4-methylbenzyl)-1-(4-morpholin-4-yl-phenyl)-butan-1-one, 2-benzyl-2-dimethylamino-1-(3,4-dimethoxy-phenyl)-butan-1-one, 2-benzyl-2-dimethylamino-1-(4-morpholin-4-yl-phenyl)-butan-1-one, and 2-methyl-1-(4-methylsulfanyl-phenyl)-2-morpholin-4-yl-propan-1-one; 4-aroyl-1,3-dioxolanes; benzoin alkyl ethers and benzil ketals, for example, benzil dimethyl ketal, phenyl glyoxalates and derivatives thereof, for example, methylbenzoyl formate; dimeric phenyl glyoxalates, for example, oxo-phenyl-acetic acid 2-[2-(2-oxo-2-phenyl-acetoxy)-ethoxy]-ethyl ester; peresters, for example, benzophenone-tetracarboxylic acid peresters, as described, for example, U.S. Pat. No. 4,777,191; halomethyltriazines, for example, 2-[2-(4-methoxy-phenyl)-vinyl]-4,6-bis-trichloromethyl-[i1,3,5]triazine, 2-(4-methoxy-phenyl)-4,6-bis-trichloromethyl-[1,3,5]triazine, 2-(3,4-dimethoxy-phenyl)-4,6-bis-trichloromethyl-[1,3,5]triazine, and 2-methyl-4,6-bis-trichloromethyl-[1,3,5]triazine; hexaarylbisimidazole/coinitiator systems, for example, ortho-chlorohexaphenyl-bisimidazole together with 2-mercaptobenzthiazole; ferrocenium compounds or titanocenes, for example, dicyclopentadienyl bis(2,6-difluoro-3-pyrrolo-phenyl)titanium; borate photoinitiators or O-acyloxime photoinitiators as described, for example, in U.S. Pat. No. 6,596,445. In an embodiment, the amount of optional secondary photoinitiator, if used, is from 0.1 wt % to 0.5 wt %, based on the weight of additive manufacturing polyelectrolyte resin 200.

Additive manufacturing polyelectrolyte resin 200 can include a photosensitizer that increases the rate of photo-initiated polymerization of anionic organic acrylate monomer 203 or shifts the wavelength at which polymerization occurs. Photosensitizers can include monoketones, diketones, or α-diketones that absorb from 400 nm to 520 nm, specifically from 450 nm to 500 nm. Exemplary photosensitizers include camphorquinone, benzil, furil, 3,3,6,6-tetramethylcyclohexanedione, phenanthraquinone, 9,10-dialkoxyanthracenes, 1-phenyl-1,2-propanedione or other 1-aryl-2-alkyl-1,2-ethanediones, cyclic α-diketones, and the like. In an embodiment, photosensitizer, if used, is present in amount from 0.1 wt % to 2 wt %, based on the weight of additive manufacturing polyelectrolyte resin 200.

In an embodiment, with reference to FIG. 6, additive manufacturing polyelectrolyte resin 200 includes chemical modifier 218 selected from the group consisting essentially of a photoabsorber 215 and an ion dispersion solvent 205 comprising an organic reactive diluent 216. In an embodiment, chemical modifier 218 is photoabsorber 215. Photoabsorber 215 absorbs light, while photoinitiator 204 initiates a chemical reaction (e.g., polymerization of anionic organic acrylate monomer 203) when exposed to light of a wavelength that produces, e.g., a free-radical from photoinitiator 204. Exemplary photoinitiators 204 include a dye of suitable solubility in additive manufacturing polyelectrolyte resin 200, e.g., a diazo dye such as 1-(2,5-dimethyl-4-(2,5-dimethylphenyl) phenyldiazenyl) azonapthalen-2-ol (InChl=1S/C₂₆H₂₄N₄O/c1-16-9-10-17(2)22(13-16)27-28-23-14-19(4)24(15-18(23)3)29-30-26-21-8-6-5-7-20(21)11-12-25(26)31/h5-15,31H,1-4H3/b28-27+,30-29+; CAS Number 1320-06-5; commercially available as Oil Red 0). In an embodiment, photoabsorber 215, if used, is present in amount from 0.005 wt % to 2.5 wt %, based on the weight of additive manufacturing polyelectrolyte resin 200. Other exemplary photoabsorbers 215 include anthracene, pyrene, naphthalene, fluorene, tetracene, pentacene, hexacene, bis(2,4-dimethoxyphenyl)-1,3,5-hexatriene (BODIPY), 2-5-bis(δ-tert-butyl-benzoxazol-2-yl)thiophene (BBOT, commercially available as Mayzo OB+), and the like.

In an embodiment, with reference to FIG. 5, chemical modifier 218 is ion dispersion solvent 205, and ion dispersion solvent 205 is organic reactive diluent 216. Exemplary organic reactive diluents 216 include dimethylacrylamide (DMAAm), hydroxyethyl methacrylate (HEMA), hydroxyethyl acrylate (HEA), N-vinyl pyrrolidinone (NVP), poly(ethylene glycol) acrylate ester (PEG-Ac), poly(ethylene glycol) methacrylate ester (PEG-MAc), and the like. In an embodiment, organic reactive diluent 216 is present in amount from 10 wt % to 70 wt %, based on the weight of additive manufacturing polyelectrolyte resin 200. In an embodiment, organic reactive diluent 216 reacts with anionic organic acrylate monomer 203 to form anionic copolymer 217. Without wishing to be bound by theory, it is contemplated that ion dispersion solvent 205 disrupts agglomeration of cationic poly-ammonium electrolyte 202 with anionic organic acrylate monomer 203 in additive manufacturing polyelectrolyte resin 200. Moreover, organic reactive diluent 216 can reduce the viscosity of additive manufacturing polyelectrolyte resin 200 and make it easier to handle. Further, organic reactive diluent 216 can affect the properties of additively manufactured article 201, such as toughness or flexibility.

Hydroxyethyl acrylate is an organic reactive diluent that is a colorless liquid with a mild odor and is miscible with organic polar solvents. When hydroxyethyl acrylate is reacted with anionic organic acrylate monomer 203, it forms a copolymer as anionic copolymer 217. The copolymer has the properties of both monomers, as well as the properties that are imparted by the reactive diluent. The properties of the copolymer can be tailored to the specific application by varying the ratio of the monomers and the type of reactive diluent used.

In an embodiment, chemical modifier 218 is ion dispersion solvent 205, and ion dispersion solvent 205 is an organic polar solvent, e.g., an alcohol such as ethanol, propanol, and the like. In an embodiment, the polar organic solvent is present in amount from 30 wt % to 50 wt %, based on the weight of additive manufacturing polyelectrolyte resin 200.

In an embodiment, additive manufacturing polyelectrolyte resin 200 includes covalent crosslinker 207. After polymerization of anionic organic acrylate monomer 203 to form anionic poly-acrylate electrolyte 208, cationic poly-ammonium electrolyte 202 and anionic poly-acrylate electrolyte 208 within (poly-ammonium)-(poly-acrylate) electrolyte complex 206 can be thermally crosslinked together to form organic reactive diluent 216. The thermal crosslinking can occur in the presence of covalent crosslinker 207. Exemplary covalent crosslinkers 207 include polyethylene glycol diacrylate (PEGDA). In an embodiment, covalent crosslinker 207 is present in amount from 0 wt % to 10 wt %, based on the weight of additive manufacturing polyelectrolyte resin 200. In an embodiment, covalent crosslinker 207 has a molecular weight from 200 g/mol to 10,000 g/mol.

Additive manufacturing polyelectrolyte resin 200 is optically absorbent at a wavelength of light used for 3D printing or stereolithography at which anionic organic acrylate monomer 203 is cured when subjected to light used for 3D printing or stereolithography. The wavelength of light used for 3D printing or stereolithography can be ultraviolet (UV), visible, infrared, or near infrared. It should be appreciated that an additive manufacturing resin is optically absorbent if it absorbs light such that when additive manufacturing polyelectrolyte resin 200 receives the light, some of the light is absorbed. The amount of light that is absorbed depends on the wavelength of the light and the properties of additive manufacturing polyelectrolyte resin 200. Accordingly, additive manufacturing polyelectrolyte resin 200 can be used in additive manufacturing to create objects (additively manufactured article 201) with a variety of colors. The color of additively manufactured article 201 is determined by the wavelength of light that is absorbed by additive manufacturing polyelectrolyte resin 200.

In an embodiment, additive manufacturing polyelectrolyte resin 200 includes branched polyethylenimine; methacrylic acid; optionally a polar organic solvent, such as ethanol or isopropanol or a reactive diluent (such as hydroxyethyl methacrylate or dimethyl acrylamide); a photoinitiator such as diphenyl(2,4,6-trimethylbenzoyl)phosphine oxide (TPO) or phenylbis(2,4,6-trimethylbenzoyl)phosphine oxide (BAPO); an optional covalent crosslinker such as polyethylene glycol diacrylate (PEGDA); and an optional photoabsorber such as Oil Red O.

Additive manufacturing polyelectrolyte resin 200 can be made in various ways. The process for making additive manufacturing polyelectrolyte resin 200 can include: combining photoinitiator 204, anionic organic acrylate monomer 203, chemical modifier 218, and optionally photoabsorber 215 in a container (e.g., a beaker, jar, bottle, and the like) to form an initial composition; homogenizing (e.g., by stirring) the initial composition; disposing the container with the initial composition in a water bath; adding cationic poly-ammonium electrolyte 202 to the initial composition with stirring to form additive manufacturing polyelectrolyte resin 200; and optionally cooling additive manufacturing polyelectrolyte resin 200 to room temperature. In an embodiment, additive manufacturing polyelectrolyte resin 200 is made by adding all ingredients together simultaneously with mixing (e.g., vortexing, shear mixing, and the like). Additive manufacturing polyelectrolyte resin 200 can be made in an opaque container to avoid light exposure.

Additive manufacturing polyelectrolyte resin 200 has numerous advantageous and unexpected benefits and uses. In an embodiment, a process for additively manufacturing an additively manufactured article 201 from additive manufacturing polyelectrolyte resin 200 includes: subjecting additive manufacturing polyelectrolyte resin 200 to a polymerizing light, additive manufacturing polyelectrolyte resin 200 including: cationic poly-ammonium electrolyte 202; anionic organic acrylate monomer 203; chemical modifier 218 selected from the group consisting essentially of photoabsorber 215 and ion dispersion solvent 205 comprising organic reactive diluent 216; and photoinitiator 204; polymerizing anionic organic acrylate monomer 203 in additive manufacturing polyelectrolyte resin 200 in response to subjecting additive manufacturing polyelectrolyte resin 200 to the polymerizing light, such that anionic poly-acrylate electrolyte 208 is formed from anionic organic acrylate monomer 203; complexing cationic poly-ammonium electrolyte 202 with anionic poly-acrylate electrolyte 208; and forming (poly-ammonium)-(poly-acrylate) electrolyte complex 206 in response to complexing cationic poly-ammonium electrolyte 202 with anionic poly-acrylate electrolyte 208, such that (poly-ammonium)-(poly-acrylate) electrolyte complex 206 comprises cationic poly-ammonium electrolyte 202, anionic poly-acrylate electrolyte 208, and ionic linkage 209 between ammonium group 210 of cationic poly-ammonium electrolyte 202 and acrylate group 211 of anionic poly-acrylate electrolyte 208 to additively manufacture additively manufactured article 201 from additive manufacturing polyelectrolyte resin 200, wherein additively manufactured article 201 comprises (poly-ammonium)-(poly-acrylate) electrolyte complex 206. In an embodiment, chemical modifier 218 is ion dispersion solvent 205 that includes organic reactive diluent 216, and the process further comprises reacting organic reactive diluent 216 with anionic organic acrylate monomer 203.

In an embodiment, the process for additively manufacturing includes: heating (poly-ammonium)-(poly-acrylate) electrolyte complex 206 above a curing temperature of (poly-ammonium)-(poly-acrylate) electrolyte complex 206; and crosslinking cationic poly-ammonium electrolyte 202 with anionic poly-acrylate electrolyte 208 in response to heating (poly-ammonium)-(poly-acrylate) electrolyte complex 206 above the curing temperature, such that ionic linkage 209 is replaced by a covalent amide bond 212 to form amide crosslinked polymer 213.

In an embodiment, the process for additively manufacturing includes vat photopolymerization to form (poly-ammonium)-(poly-acrylate) electrolyte complex 206. In an embodiment, the process for additively manufacturing includes disposing additive manufacturing polyelectrolyte resin 200 in vat photopolymerization 3D printer 214. In an embodiment, the process for additively manufacturing includes subjecting additive manufacturing polyelectrolyte resin 200 in vat photopolymerization 3D printer 214 to patterned light exposure to polymerize anionic organic acrylate monomer 203 of additive manufacturing polyelectrolyte resin 200. In an embodiment, the process for additively manufacturing includes moving (poly-ammonium)-(poly-acrylate) electrolyte complex 206 relative to the polymerizing light to polymerize more of anionic organic acrylate monomer 203 and to produce more of (poly-ammonium)-(poly-acrylate) electrolyte complex 206, such that additively manufactured article 201 is three-dimensionally printed via photopolymerization of anionic organic acrylate monomer 203 in presence of cationic poly-ammonium electrolyte 202.

In an embodiment, additively manufactured article 201 is three-dimensionally printed. In an embodiment, (poly-ammonium)-(poly-acrylate) electrolyte complex 206 is insoluble in ion dispersion solvent 205. In an embodiment, additively manufactured article 201 including (poly-ammonium)-(poly-acrylate) electrolyte complex 206 is recyclable. In an embodiment, additively manufactured article 201 including (poly-ammonium)-(poly-acrylate) electrolyte complex 206 is flame retardant. In an embodiment, additively manufactured article 201 including (poly-ammonium)-(poly-acrylate) electrolyte complex 206 is biocompatible.

In an embodiment, a process for additively manufacturing an additively manufactured article 201 from additive manufacturing polyelectrolyte resin 200 includes: pouring additive manufacturing polyelectrolyte resin 200 into the vat of a stereolithography 3D printer; and operating the printer to produce solid parts of additively manufactured article 201.

In an embodiment, a process for additively manufacturing an additively manufactured article 201 from additive manufacturing polyelectrolyte resin 200 includes: spin coating additive manufacturing polyelectrolyte resin 200 on a substrate; forming a thin film of additive manufacturing polyelectrolyte resin 200 on the substrate; and curing the thin film in response to exposing the thin film to a selected wavelength of light, e.g., UV light.

In an embodiment, a process for additively manufacturing an additively manufactured article 201 from additive manufacturing polyelectrolyte resin 200 includes: pouring additive manufacturing polyelectrolyte resin 200 into a 3D printing vat; printing additively manufactured article 201 with the 3D printer; removing photopolymerized additively manufactured article 201 from the 3D printer's build plate; and curing additively manufactured article 201 with UV irradiation to produce amide crosslinked polymer 213 in additively manufactured article 201 from (poly-ammonium)-(poly-acrylate) electrolyte complex 206. In an embodiment, additive manufacturing polyelectrolyte resin 200 includes 17.2 wt % PEI, 34.4 wt % MAA, 2 wt % TPO, and 46.4 wt % HEMA, based on a weight of additive manufacturing polyelectrolyte resin 200. In an embodiment, additively manufactured article 201 is recyclable, and the additive manufacturing polyelectrolyte resin 200 includes 21.5 wt % PEI, 43 wt % MAA, 2 wt % BAPO, and 33.5 wt % isopropanol. It is contemplated that thermal treatment of additively manufactured article 201 provides to improved mechanical properties and enhanced resistance to solvent exposure.

In an embodiment, a process for additively manufacturing an additively manufactured article 201 from additive manufacturing polyelectrolyte resin 200 includes: preparing additive manufacturing polyelectrolyte resin 200; pouring additive manufacturing polyelectrolyte resin 200 into the vat of a stereolithography (i.e. vat photopolymerization) printer; photopolymerizing anionic organic acrylate monomer 203 of additive manufacturing polyelectrolyte resin 200 in the printer to produce anionic poly-acrylate electrolyte 208 from anionic organic acrylate monomer 203; forming ionic crosslinks between cationic poly-ammonium electrolyte 202 and anionic poly-acrylate electrolyte 208 to produce (poly-ammonium)-(poly-acrylate) electrolyte complex 206 and additively manufactured article 201; forming sequential layers of (poly-ammonium)-(poly-acrylate) electrolyte complex 206 by subjecting some of the remaining anionic organic acrylate monomer 203 to photopolymerization; and obtaining additively manufactured article 201 as a final part when the print has concluded.

In an embodiment, a process for additively manufacturing an additively manufactured article 201 from additive manufacturing polyelectrolyte resin 200 includes: subjecting additively manufactured article 201 with (poly-ammonium)-(poly-acrylate) electrolyte complex 206 to thermal crosslinking by heating additively manufactured article 201 from 120° C. to 220° C. (e.g., to 180° C.); and cooling additively manufactured article 201 to room temperature.

In an embodiment, a process for recycling additive manufacturing polyelectrolyte resin 200 from additively manufactured article 201 includes: providing additively manufactured article 201; contacting additively manufactured article 201 with a basic solution (e.g., by disposing additively manufactured article 201 in a container that includes a basic solution); removing charged groups from polyammonium through their deprotonation in basic solution; reversing the ionic network among (poly-ammonium)-(poly-acrylate) electrolyte complex 206 that maintains structural integrity of additively manufactured article 201; dissolving (poly-ammonium)-(poly-acrylate) electrolyte complex 206 as the ionic bonds are eliminated; optionally adding the dissolved complex to a second batch of virgin (i.e., unused) additive manufacturing polyelectrolyte resin 200; and printing a new additively manufactured article 201 from the combination of dissolved and virgin additive manufacturing polyelectrolyte resin 200.

With regard to printing additively manufactured article 201, additive manufacturing polyelectrolyte resin 200 can be poured into a vat photopolymerization printer at or above room temperature (e.g., greater than 20° C.). The 3D printer can be various makes or models with various sizes or wavelengths. Once additive manufacturing polyelectrolyte resin 200 is disposed in the printer vat, the printer is operated to make three dimensional additively manufactured article 201, wherein additively manufactured article 201 is formed via selective curing of illuminated areas of the printer, followed by raising the build plate and polymerization of subsequent layers to build, e.g., complex objects of arbitrary shape of additively manufactured article 201. Objects of additively manufactured article 201 form thermoset-like networks on the basis of ionic bonds, as anionic organic acrylate monomer 203 is photopolymerized into anionic poly-acrylate electrolyte 208 and forms (poly-ammonium)-(poly-acrylate) electrolyte complex 206 with cationic poly-ammonium electrolyte 202 that is also present in additive manufacturing polyelectrolyte resin 200. After the print is completed, additively manufactured article 201 is removed from the build plate and can optionally be subjected to a subsequent light treatment to increase monomer conversion.

Additively manufactured article 201 Having (poly-ammonium)-(poly-acrylate) electrolyte complex 206 can be subjected to thermal curing by heating additively manufactured article 201 with (poly-ammonium)-(poly-acrylate) electrolyte complex 206 to a temperature from 120° C. to 200° C. The thermal treatment causes condensation reactions between associated ammonium groups of cationic poly-ammonium electrolyte 202 and carboxylate groups from anionic poly-acrylate electrolyte 208. The condensation reaction releases water and converts the ammonium/carboxylate pair into a covalent amide bond 212. As a result, the modulus of additively manufactured article 201 increases, and additively manufactured article 201 has greater resistance to thermal degradation and increased resistance to swelling or dissolution in solvent.

additively manufactured article 201 With (poly-ammonium)-(poly-acrylate) electrolyte complex 206 can be subjected to recycling back to additive manufacturing polyelectrolyte resin 200 and subsequent printing of a new additively manufactured article 201. Here, additively manufactured article 201 can be exposed to a basic solution (e.g., ≥0.5 M base). The base deprotonates the polycation cationic poly-ammonium electrolyte 202, leading to a loss of charge and a reversal of the ionic bonding network upon which additively manufactured article 201 derives structure and rigidity. After reversal of the ionic bonds, additively manufactured article 201 loses solvent resistance and dissolves in the solution. This dissolved additive manufacturing polyelectrolyte resin 200 can be incorporated into a virgin resin, e.g., a 5 wt % additive to the resin, which can be used for further prints that includes a fraction of recycled additive manufacturing polyelectrolyte resin 200.

It is contemplated that, during printing, additive manufacturing polyelectrolyte resin 200 can be subjected to an LED wavelength of 405 nm with parts printed with layer times ranging from 3 s to 5.5 s. For additively manufactured article 201 with BAPO as photoinitiator, the optional further UV post-curing under broad spectrum UV lamps for 10 minutes improves mechanical strength. During thermal curing, parts can be cured in an oven set to 180° C. for 20 hours, cooled to 150° C. for 4 hours, and removed from oven. For recycling additive manufacturing polyelectrolyte resin 200 from additively manufactured article 201, a dissolution solution can include 15 wt % of (poly-ammonium)-(poly-acrylate) electrolyte complex 206 dissolved in 1 M NaOH and, once dissolved, can be included into fresh resin at a 5 wt % loading. Objects can be printed according to the process for additively manufacturing.

Vat polymerization is a process of creating three dimensional objects from a liquid photopolymer by using a laser or another light source to cure (harden) the liquid one layer at a time. The object is created by lowering a platform into a vat of liquid photopolymer, and then curing the liquid one layer at a time. The platform is then raised, and the process is repeated until the object is complete. Stereolithography (SLA) is a type of vat polymerization that uses a laser to cure the liquid photopolymer. The laser is scanned across the surface of the liquid, curing the liquid in a specific pattern. The platform is then lowered, and the process is repeated until the object is complete. SLA is a very precise process, and it can be used to create objects with very fine details. It is also a very fast process, and it can be used to create objects with complex geometries.

Polymerization of anionic organic acrylate monomer 203 can occur at various wavelengths. Wavelengths of vat photopolymerization 3D printer 214 for polymerization of anionic organic acrylate monomer 203 can include visible light from 400 nm to 700 nm, near infrared light from 700 nm to 1000 nm, or short-wave infrared from 1000 nm to 3000 nm. Operation with a wavelength near 1550 nm can provide integration with a large number of fiber optic components designed for telecommunications, making additive manufacturing polyelectrolyte resin 200 scalable and compatible with off-the-shelf optical characterization tools. The wavelength of light used for 3D printing and stereolithography is typically in the ultraviolet range. The wavelength of UV light used depends on the type of additive manufacturing polyelectrolyte resin 200 being used. It should be appreciated that when anionic organic acrylate monomer 203 forms anionic poly-acrylate electrolyte 208, it undergoes a chemical reaction in which the monomers are joined together to form the larger molecule of anionic poly-acrylate electrolyte 208 that involves the formation of covalent bonds between anionic organic acrylate monomer 203.

Additive manufacturing polyelectrolyte resin 200 is a homogeneous optically clear liquid with viscosity greater than water. PEI and MAA are both neutral species normally and gain their charge through and acid-base reaction that occurs when they are mixed. This reaction also significantly increases the viscosity of the mixture compared to either individual component. Certain additive manufacturing polyelectrolyte resin 200 types can have a color, e.g., a slight yellow hue, e.g., when BAPO is used as the photoinitiator. Additive manufacturing polyelectrolyte resin 200 reacts in response to light exposure (e.g., λ<410 nm) to form a solid (poly-ammonium)-(poly-acrylate) electrolyte complex 206 via photopolymerization of the methacrylic acid into poly(methacrylic acid) through ionic interactions with polyethylenimine.

In an embodiment, additive manufacturing polyelectrolyte resin 200 includes 21.5 wt % PEI, 43 wt % MAA, 2 wt % BAPO, and 33.5 wt % isopropanol. Such additive manufacturing polyelectrolyte resin 200 is photoactive, curing into a solid with UV light exposure. In an embodiment, additive manufacturing polyelectrolyte resin 200 includes 21.5 wt % PEI, 43 wt % MAA, 2 wt % BAPO, 32.5 wt % isopropanol, and 1 wt % PEGDA. This resin is photoactive and cures into a solid with UV exposure. In an embodiment, additive manufacturing polyelectrolyte resin 200 includes 17.2 wt % PEI, 34.4 wt % MAA, 2 wt % TPO, and 46.4 wt % HEMA, DMAAm, or a 1:1 mass ratio of the two, wherein the resin is photoactive and cures into a solid with UV exposure.

Additively manufactured article 201 can be a rigid plastic with a modulus from 200 kPa to >1 GPa, depending on the chemical constituents of additive manufacturing polyelectrolyte resin 200 and amount of hydration. When immersed in water, the modulus of additively manufactured article 201 decreases as it swells. Thermally crosslinked additively manufactured article 201 are less susceptible to both modulus loss and swelling. If additively manufactured article 201 is printed from additive manufacturing polyelectrolyte resin 200 containing a covalent crosslinker (e.g., PEGDA), then swelling can increase ˜3-fold. Parts of additively manufactured article 201 printed with solvent instead of reactive diluent exhibit a glass transition temperature by differential scanning calorimetry. Parts of additively manufactured article 201 that are thermally crosslinked or composed with reactive diluents instead of solvents exhibit no visible glass transition temperature by DSC. Thermally post cured parts of additively manufactured article 201 maintain their modulus at higher temperatures than non-thermally-cured parts of additively manufactured article 201. The carboxylate anion stretch from non-thermally-cured parts of additively manufactured article 201 disappears after thermal curing in FTIR spectroscopy.

Various methods and materials for printing with additive manufacturing polyelectrolyte resin 200 can occur, including those described in U.S. patent application Ser. No. 17/271,360 and International Patent Application No. PCT/US2023/015907, which are incorporated by reference herein in their entirety.

Additive manufacturing polyelectrolyte resin 200, additively manufactured article 201, and additively manufacturing described herein have numerous beneficial uses and properties. Additively manufactured article 201 is a solid object that can be made by a stereolithographic 3D printer and can have an arbitrary shape through photopolymerization of anionic organic acrylate monomer 203 in additive manufacturing polyelectrolyte resin 200. The solid includes (poly-ammonium)-(poly-acrylate) electrolyte complex 206 as a polyelectrolyte complex a networked plastic-like material held together via ionic linkage 209 instead of covalent crosslinks between cationic poly-ammonium electrolyte 202 and anionic poly-acrylate electrolyte 208. Additively manufactured article 201 can be thermally treated after printing to convert ionic linkage 209 to covalent crosslinks that change the mechanical and swelling properties of additively manufactured article 201. Moreover, additively manufactured article 201 with (poly-ammonium)-(poly-acrylate) electrolyte complex 206 in an absence of covalent crosslinks can be a recyclable plastic part that can be used as a biological scaffold, an environmentally responsive (e.g. water sensitive) material, or a flame retardant object, or combination thereof.

The printed additively manufactured article 201 of arbitrary shape and dimension can be produced through vat photopolymerization, e.g., stereolithography. In an embodiment, photopolymerized poly(methacrylic acid) can be poly(acrylic acid), poly(hydroxyethyl methacrylate phosphate ester), or a copolymer of any of these with one or more of hydroxyethyl methacrylate, hydroxyethyl acrylate, N-vinyl pyrrolidinone, dimethyl acrylamide, PEG-Ac, or PEG-Mac. Polyethylenimine can be any polycation herein, including: poly(vinyl amine), tetraethylene pentamine (TEPA), linear polyethylenimine (LPEI), chitosan (CH), or poly(allyl amine) (PAAm). Ionic linkage 209 can be a linkage between ammonium-carboxylate, ammonium-phosphate, ammonium-sulfate, alkylammonium-carboxylate, alkylammonium-phosphate, alkylammonium-sulfate, or a combination thereof. Ionic linkage 209 can be a networking bond alone or in presence of covalent crosslinker 207. Ionic linkage 209 can be doped by including a small molecule, salt, or ionic liquid in additive manufacturing polyelectrolyte resin 200 or by-treatment of additively manufactured article 201.

The thermally crosslinked additively manufactured article 201 (that includes amide crosslinked polymer 213) can have an arbitrary shape or dimension according to the original shape or dimension of the uncrosslinked additively manufactured article 201. In the crosslinked additively manufactured article 201, residual ionic linkages can be present or absent, and when present can be in a selected ratio to the covalent linkages. The residual ionic linkages can be doped with additional charged species. Amide bond 212 formed from thermal crosslinking will appear in FTIR analysis of the printed after thermal crosslinking.

The articles and processes herein are illustrated further by the following Examples, which are non-limiting.

### Example 1

Reactive Diluents Improve 3D-Printed Polyelectrolyte Photopolymer Complex Mechanical Properties and Thermal Stability

Polyelectrolyte complexes (PECs), ionically bound assemblies of oppositely charged polymers, have wide ranging applications spanning medicine, fire safety, and electronic materials. For years, PECs presented processing challenges owing to their ionic bonds which has limited them to uses as coatings. Chemistry was recently developed to additively manufacture PECs of polyethylenimine and polymethacrylic acid through vat photopolymerization, but the use of solvent compromised the mechanical properties of the parts. Here, we use two reactive diluents, hydroxyethyl methacrylate and dimethyl acrylamide, as a substitute for the previously used solvent in printable PEC resins. Parts printed with these reactive diluents have nearly identical processing parameters but exhibit significant differences in thermomechanical properties and water resistance. Thermally driven amidization of the carboxylate and ammonium groups yield a further dimension of control over the properties of the parts. The combination of spatial, thermomechanical, and hydrophilicity control promise to dramatically expand the application space of polyelectrolyte materials.

The application space of polyelectrolyte complexes (PECs) spans regenerative medicine, drug delivery, flame retardants, and electronic materials. PECs are a type of supramolecular assembly between oppositely charged polymers—or in some cases, nanoparticles (e.g. clays, graphene oxide, etc.)—whose association is entropically driven by the expulsion of counterions. This yields an equilibrium which can be adjusted by salinity, pH, and hydration to yield the unique properties of saloplasticity, self-healing, and recyclability. However, widespread adoption of PECs has been hindered by the challenges inherent in their processing. The ionic bonds that give rise to the unique properties of PECs lead them to behave like 100% physically crosslinked materials and they are prone to significant dimensional change from the few viable forms of melt processing developed by Schlenoff et al. The challenging processing of bulk PECs has relegated PECs primarily to use as coatings that are primarily only tunable in one dimension: thickness.

Here is described a three-dimensional processing technique for solid polyelectrolyte complexes using a photopolymer additive manufacturing method. A polyamine homopolymer was paired with an acidic monomer and a photoinitiator. The resultant resin, a polyammonium species paired with an anionic monomer after an acid-base reaction, was 3D printed using vat photopolymerization technology. In short, this form of 3D printing uses patterned light to selectively cure layers of liquid resin into a solid on a build plate, which is lifted between projections to enable the layer-by-layer formation of a solid object. Certain conventional polyelectrolyte photopolymer complexes (photoPECs) have three-dimensional control over polyelectrolyte materials but suffered from poor mechanical properties, even after a thermal cure to yield covalent amide bonds in place of the ionic bonds between ammonium groups and carboxylate groups. While these materials are still interesting as potential “4D” materials, further improvement is necessary to facilitate more widespread usage of photoPECs, which is provided by additive manufacturing polyelectrolyte resin 200.

A chief problem with conventional technology is incorporation of solvent (isopropanol, nearly one third of the resin by mass) in the resin to modulate the significant viscosity of preassociated polyethylenimine and methacrylic acid. The solvent evaporates out after the print was complete which caused poor optical clarity, attributed to voids from evaporated solvent. These voids were hypothesized to be the culprit behind the poor mechanical properties of the dry photoPECs. A popular route in other photopolymer resins to handle high viscosities without compromising other properties is to make use of molecules called reactive diluents. These are typically monofunctional polymerizable species with similar reactivity to other components of the resin. They are sometimes present in very high quantities and account for nearly 20% by mass of the popular open-source resin PR48. In this work, we study several reactive diluents as a replacement for isopropanol in our photoPEC resins and study the influence of these compounds on the printability of the resins. Resins making use of hydroxyethyl methacrylate, dimethylacrylamide, and a combination therein are studied to understand the thermal, mechanical, and water resistance of printed parts. The use of reactive diluents gives promise for wider utility of photoPECs, with the choice of reactive diluent and thermal cure both yielding significant impacts on the studied properties.

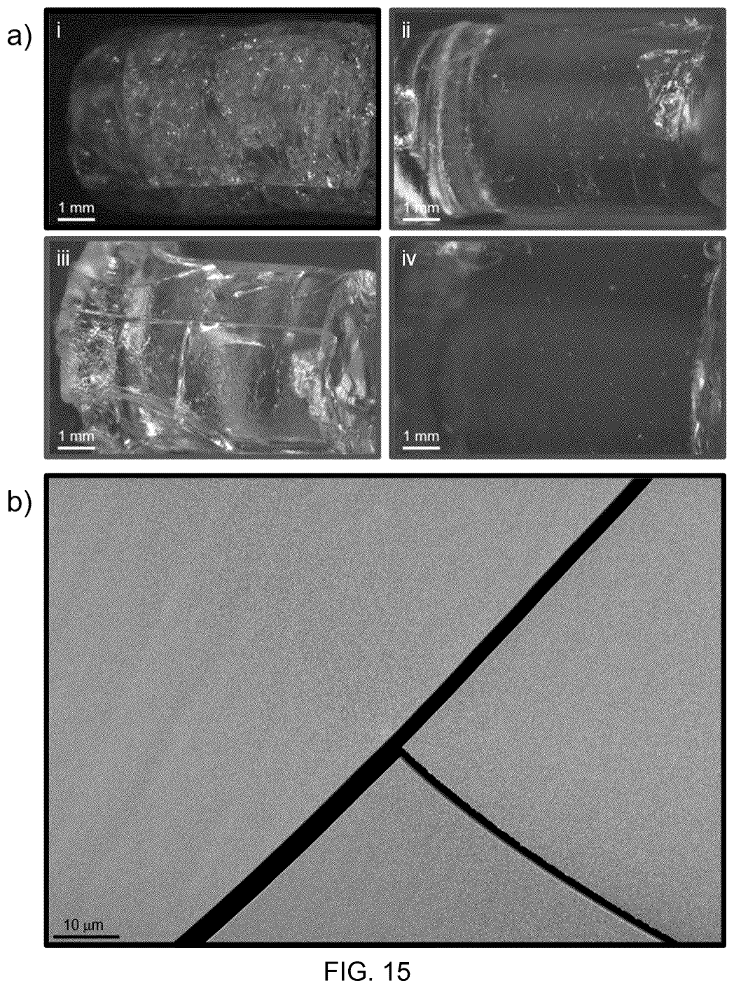

2.1 Resin Formulation and Printing. In an effort to avoid the poor mechanical properties observed in the first additively manufactured PECs, a variety of commercially available comonomers were evaluated to use as reactive diluents. It was found that only very polar molecules could sufficiently dissolve the PEI:MAA precomplex as the PEI was added to the solution. Examples of monomers that insufficiently dissolved the precomplex include styrene, vinyl toluene, and N-vinyl pyrrolidinone. Addition of vinyl acetate yielded a homogeneous solution, but it was extremely viscous and a highly absorbing red colored liquid that could not be photopolymerized and thus was not considered further. In contrast, polar molecules such as hydroxyethyl methacrylate (HEMA), and dimethyl acrylamide (DMAAm) successfully stabilize the PEI:MAA precomplex and yield shelf-stable resins. Due to inappropriately high viscosity, the concentration of PEI and MAA were each lowered to 4 mol/kg resin from 5 mol/kg resin in the studied reactive diluent-containing resins. The formulations of all resins evaluated in this study are summarized in FIG. 7. Resins utilizing HEMA (PEC-H), DMAAm (PEC-D), or a 1:1 weight ratio mixture of HEMA and DMAAm (PEC-HD) are evaluated in this study. A resin containing 5 mol/kg PEI:MAA with isopropanol (IPA) as a diluent (PEC-1) is studied as a control. All resins were prepared with 2 wt % TPO as photoinitiator. The concentration of photoinitiator was held constant instead of the ratio of reactive groups to photoinitiator in an attempt to give all prepared resins similar absorption profiles (FIG. 15).

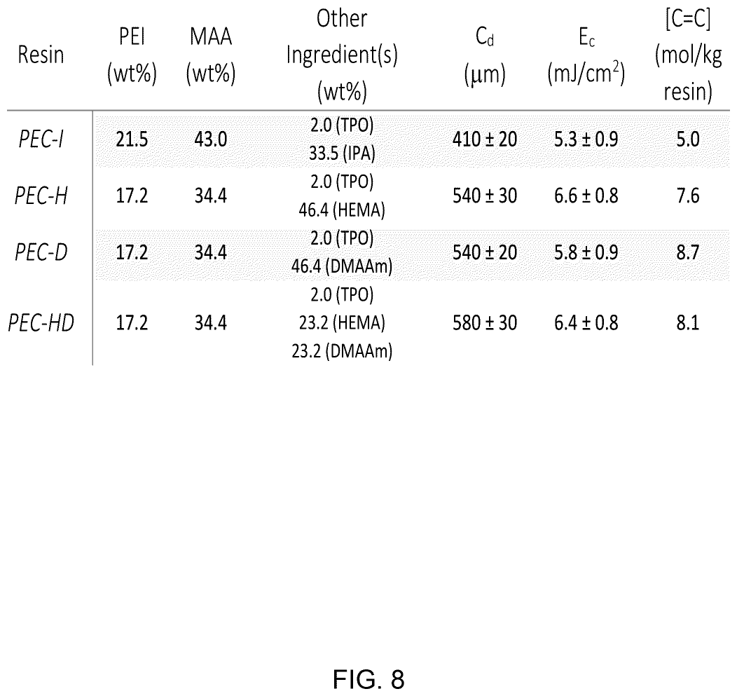

A schematic of the photopolymerization of the resin is shown in FIG. 8a. A mixture of MAA and reactive diluent is copolymerized and solid is formed by ionic complexation between the anionic polymethacrylate group of poly(methacrylic acid) (PMAA) and PEI's protonated amine groups. To understand the printing parameters of these resins, working curves were constructed on a vat photopolymerization printer. Fitting a semilog plot of cure depth (Cd) vs light dose (E₀) yields two fit parameters: Dₚ and E_{c}, which are summarized in FIG. 7. The depth of light penetration, Dₚ, is the depth at which the intensity of transmitted light drops to 37% of its initial value. Ideally, Dₚ correlates directly to the absorbance of the resin at the wavelength of the printer. Despite varying chemistries, all of the reactive diluent resins possess approximately equal Dₚ values of 550 mm. This is confirmed from UV/Visible spectroscopy, shown in FIG. 15, where all studied resins have similar absorbances at 405 nm. The critical dose for gelation, E_{c}, is evaluated from the x-intercept on the working curve. Once again, the studied resins do not exhibit significant differences from one another, despite the higher concentration of reactive groups in the reactive diluent resins. This provides further evidence for ionic complexation being the driving mechanism for solid formation in these resins, as PEC-I actually has the lowest E_{c} and simultaneously has the lowest concentration of reactive groups, but the highest concentration of purely ionic interactions (i.e. 5 mol/kg ionic bonding groups for PEC-I and 4 mol/kg for the other resins).

All parts printed from resins containing reactive diluent could be sliced to 100 mm layers and printed with 3 s layer cure times (corresponding to ≈7 mW/cm² energy dose), while successful prints with PEC-I required 5.25 s layer (≈12 mW/cm²). The working curves predict layer thicknesses of ≈60 mm for the reactive diluent resins and ≈340 mm for PEC-1. These results highlight the limitations of current working curve techniques since the theoretical layer thickness is shorter than the realized layer thickness. It is possible that the form factor of the working curve technique utilized leads to more oxygen inhibition which skews the measurement. The much thicker theoretical layer height of PEC-1 correlates with our previous work, and may suggest that a purely ionic network is more fragile in the early stages of gelation. The addition of the reactive diluents may create a denser or more mechanically rigid material capable of withstanding the stresses of lifting the freshly polymerized layer from the window material

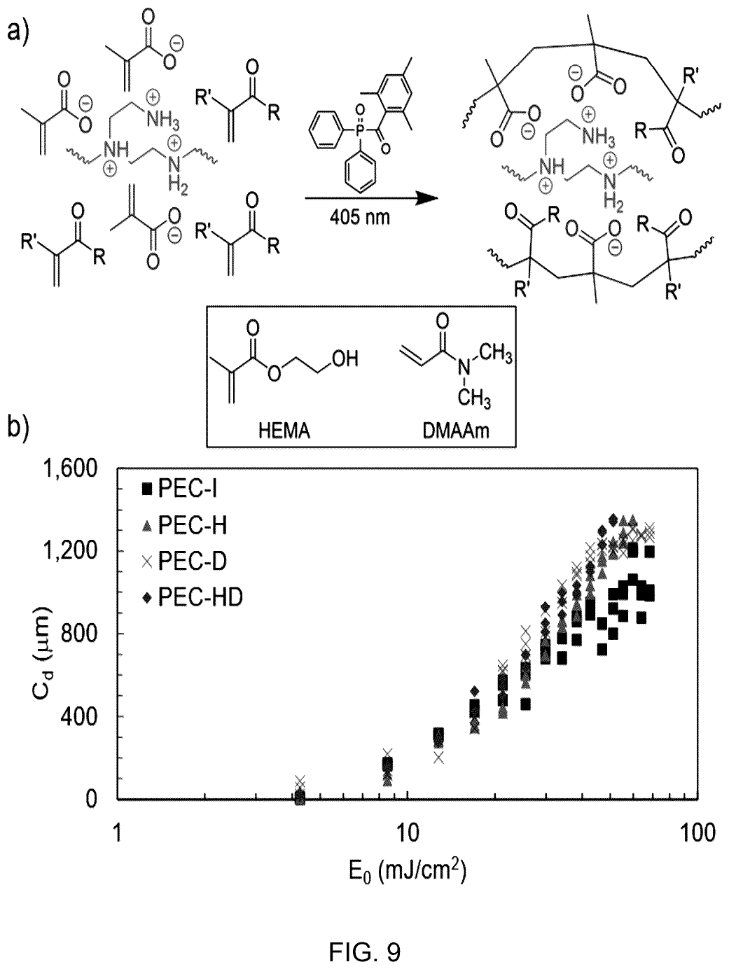

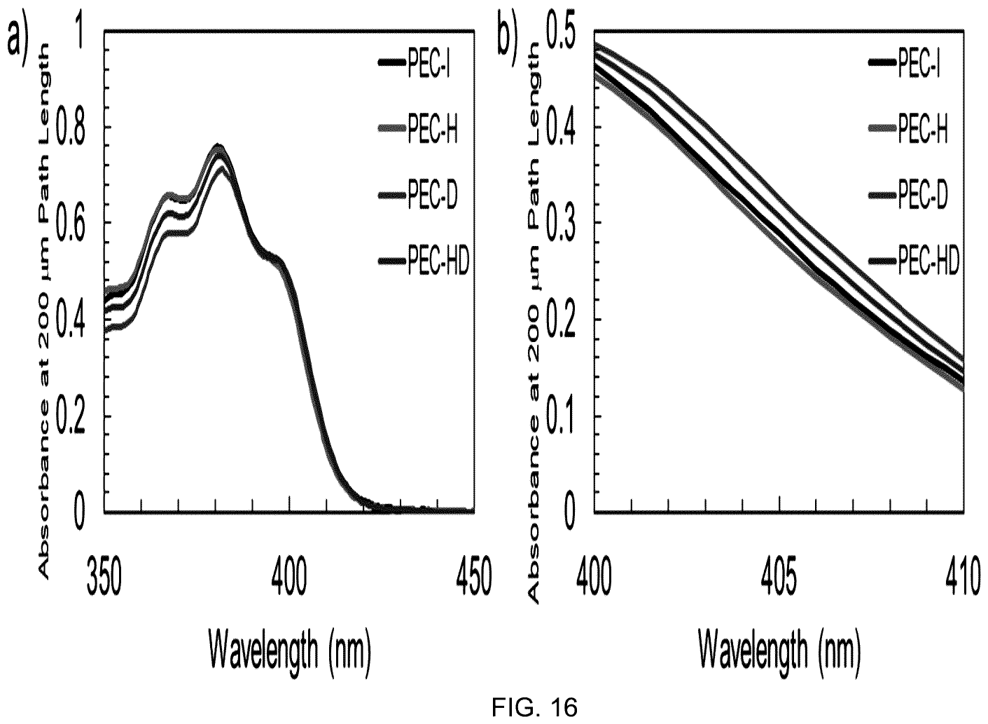

2.2 Thermal Analysis of Printed Parts. Printed parts were characterized by thermogravimetric analysis (TGA) in air. Results from TGA on printed parts of each composition are shown in FIG. 9a. Comparisons between linear combinations of the degradation profiles of PEC-I and the reactive diluents (TGA data for photopolymerized homopolymers of HEMA and DMAAm are shown in FIG. 16, supporting information) and actual measured degradation curves of PEC-H, PEC-D, and PEC-HD are shown in FIG. 9b. The different degradation profile of each sample allows for inference of the composition of the printed parts. It is clear that PEC-H deviates substantially from the weighted average of PEC-I and poly(HEMA) (PHEMA) during the degradation process. One potential explanation for this is thermally driven esterification between the hydroxyl group of PHEMA and the carboxylate group of PMAA. While analogous formation of amides between polyamines and polycarboxylates have previously been demonstrated in polyelectrolyte films, formation of esters in this way has not been documented previously. If the thermally driven esterification is occurring, then it would delay the degradation of PEC-H, which is seen in FIG. 9b. The theoretical curves of PEC-D and PEC-HD both match more closely with the collected data.

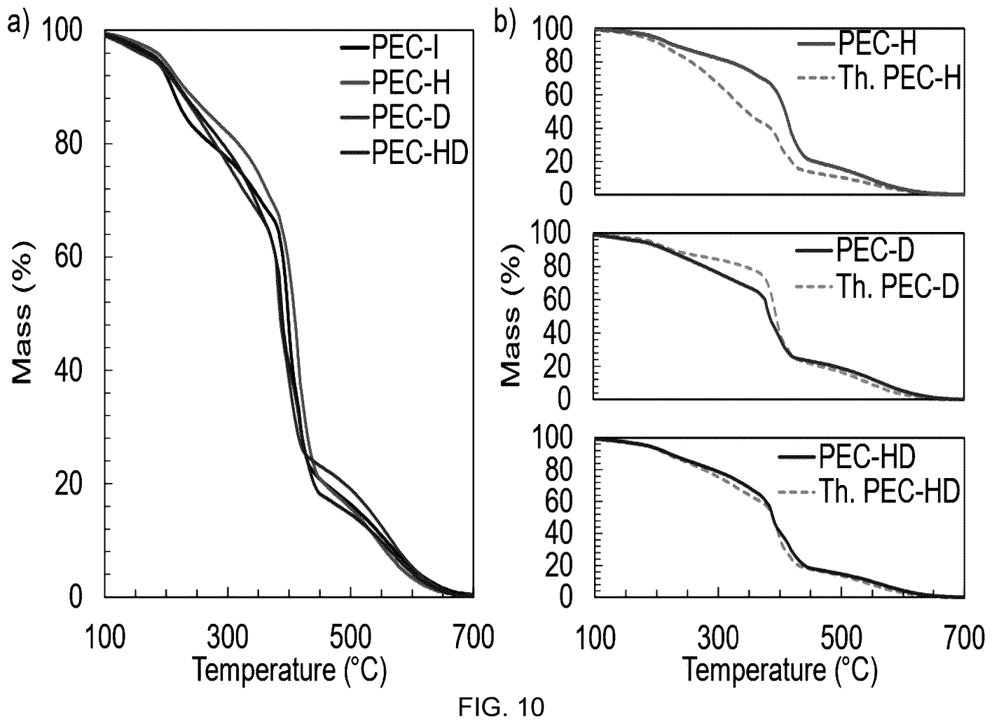

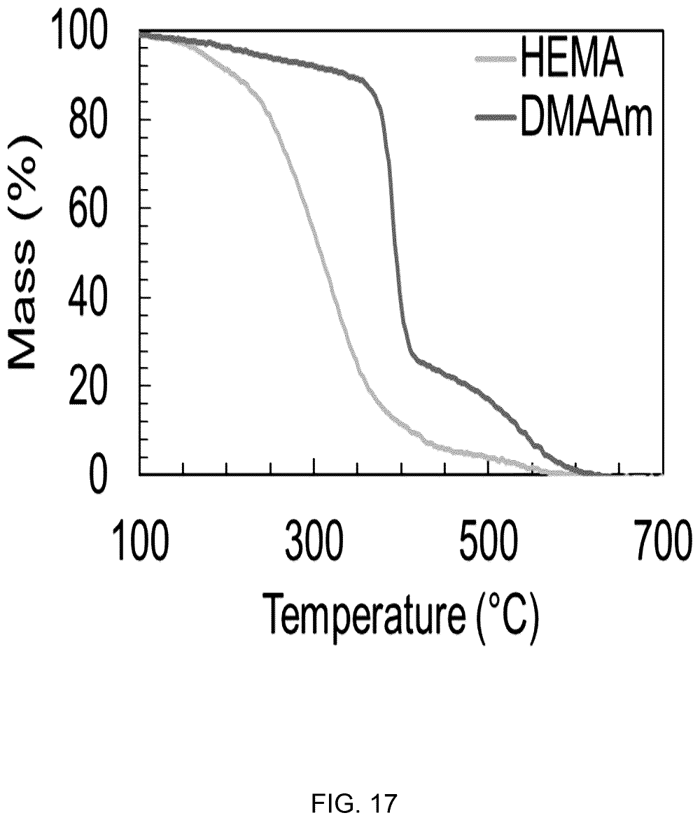

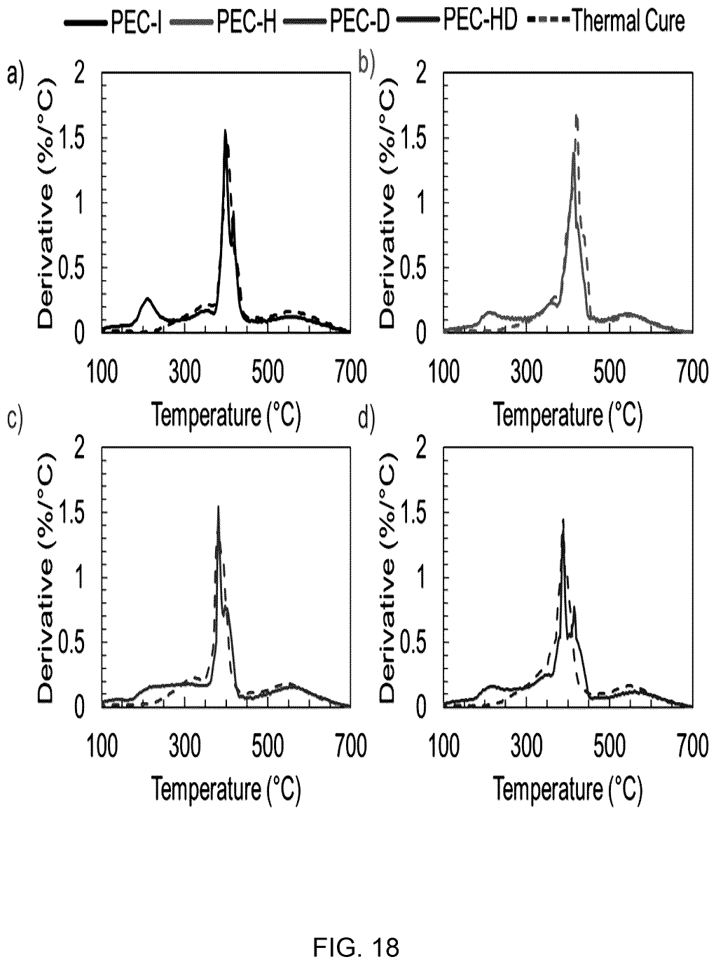

The TGA data shown in FIG. 9 show that all compositions of printed part undergo a weight change beginning above 100° C. and accelerating until ≈210° C. (differential thermograms are shown in FIG. 17). This is thought to be a result of the formation of amide bonds between the PEI's ammonium groups and PMAA's carboxylate groups. Thermal treatment imparts crosslinked behavior to polyamine/polycarboxylate thin films. Parts were thermally crosslinked at 180° C. for 20 hours and analyzed by both TGA and Fourier Transform Infrared (FTIR) spectroscopy, which are shown in FIG. 10. The degradation temperature is higher after this thermal treatment, and the weight loss seen around 210° C. is not observed in these samples in TGA. The disappearance of the carboxylate stretch centered ≈1540 cm⁻¹ along with the appearance of an amide stretch at ≈1660 cm⁻¹ confirms the formation of this bond in the treated parts (full FTIR spectra are available in FIG. 18). The increased thermal stability and FTIR data strongly suggest the formation of a covalently crosslinked network instead of the ionically crosslinked network that is initially printed.

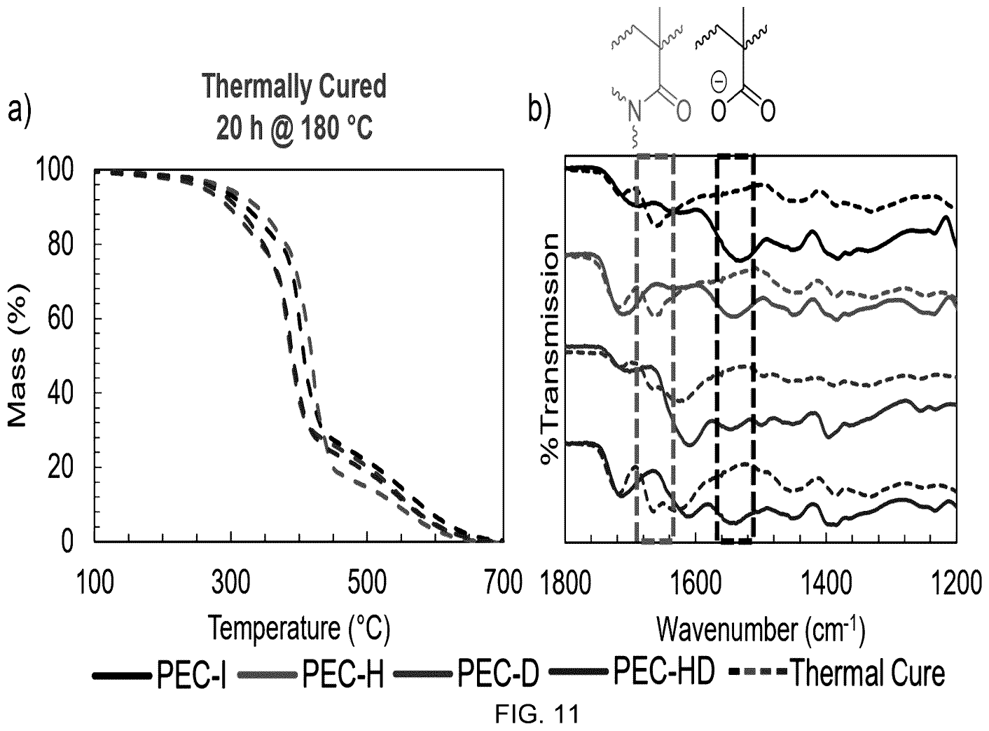

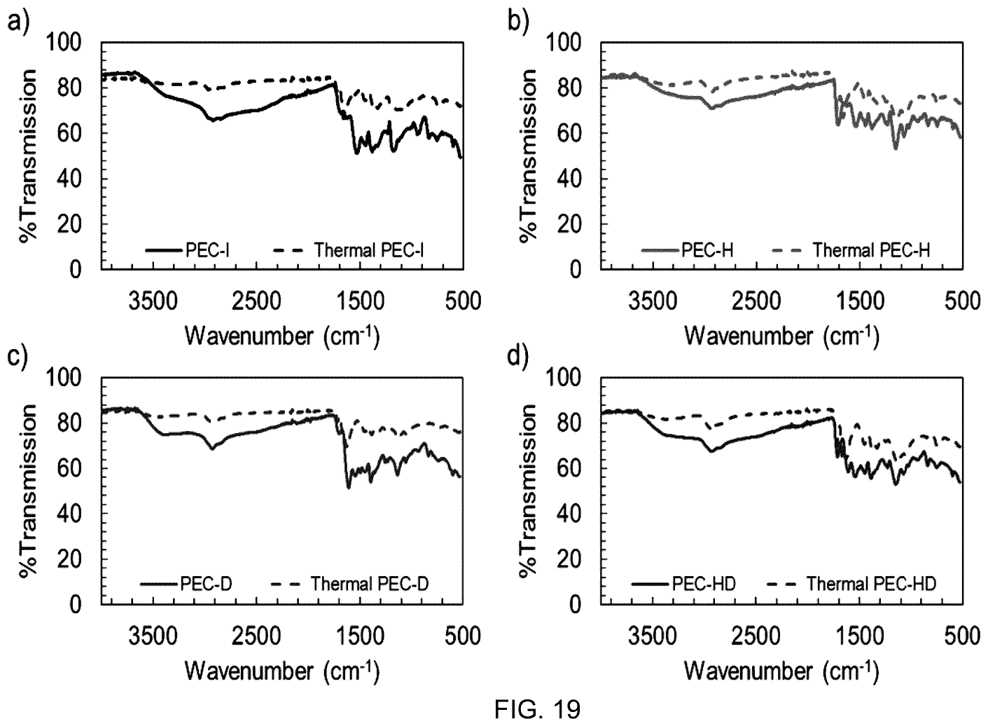

Thermally-driven amidization is exothermic, and this was also noted during differential scanning calorimetry of printed parts (available in FIG. 19). The enthalpies of amidization (ΔH_{amide}) for the uncured parts are shown in FIG. 11. The most exothermic part is PEC-I with −148 J/g, which is expected as it is composed entirely of PEI and PMAA. The lower values for the other parts indicate incorporation of groups that do not participate in the amidization reaction, diluting the heat evolved per gram of printed material. PEC-I parts also showed an observable glass transition temperature (T_{g}) in DSC, while the other parts did not. The reason for this is unclear, but the more complicated mixture and the introduction of hydrogen bond donor and acceptor groups (from HEMA and DMAAm, respectively), in addition to the existing ionic network between PEI and PMAA, could lead to difficulty in measuring a T_{g} thermally.

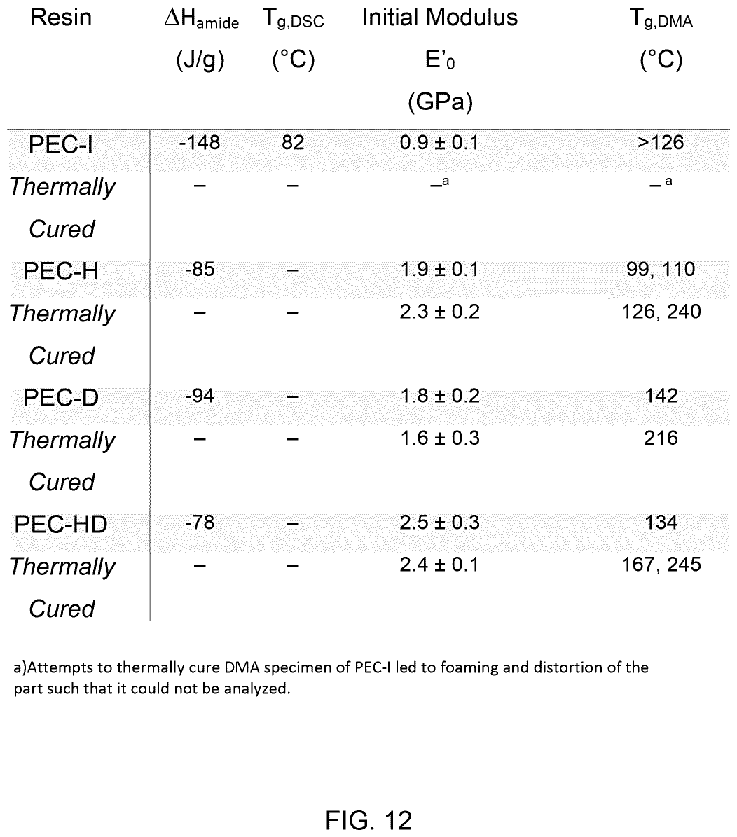

2.3 Mechanical Analysis of Printed Parts. The influence of thermal crosslinking on part mechanical properties was evaluated through dynamic mechanical analysis (DMA) by testing printed bars in a dual-cantilever arrangement at 1 Hz with a temperature ramp. Stress was applied parallel to the printing plane to facilitate easier mounting of the printed parts in the clamps of the DMA. Modulus values could be higher for parts printed with the layers deposited perpendicular to the stress axis. The plots of storage modulus (E′) and tan(d) vs temperature are shown in FIG. 12a and FIG. 12b, respectively. Normalized storage moduli are shown to better show the change in thermomechanical properties as a function of the reactive diluent. Initial modulus values are available in FIG. 11. The trace for PEC-I is incomplete because parts made from PEC-I routinely failed around 125° C. This was expected due to the overall poor durability of these parts and is likely related to the large content of isopropanol, which evaporates after printing and causes voids which could serve as failure points under stress at elevated temperatures.

It is apparent from FIG. 12a that the as-printed parts lose mechanical strength significantly earlier and to a greater extent than the thermally-cured parts. This supports the hypothesis that thermal curing creates a covalently crosslinked network which would thus exhibit higher transition temperatures. The as-printed PECs go through a thermal transition between 100° C. and 140° C. where a significant portion of their mechanical stiffness is lost. However, as the parts are further heated past these transitions, they begin to stiffen once again and return to around 10% of their starting storage modulus. This stiffening is once again attributed to thermal crosslinking of the photoPECs. While significant spectroscopic evidence for this phenomenon have been shown repeatedly in the literature, we believe that this is the first time that any form of in-situ realization of the mechanical property changes from amidization in a polyelectrolyte complex have been monitored. This observation highlights the utility of spatial patterning of PECs to allow for improved metrology of PEC properties through ease of sample preparation.

The plots of tan(δ) vs temperature reveal more unique behavior of photoPECs. Typically, a plot of tan(δ) vs temperature will yield a symmetric single peak which correlates with the glass transition temperature T_{g} of the material. Instead, the trace of tan(δ) for PEC-H shows two peaks, and the traces for PEC-D and PEC-HD each show a shoulder. The split/shouldered peaks indicate that the photoPECs may have multiple T_{g}'s. One potential reason for multiple transition temperatures could be the microstructure of the copolymer formed between MAA and HEMA and/or DMAAm. In any pairing of these three monomers, literature reactivity ratios have been demonstrated to be extremely asymmetric, with r₁/r₂ ratios in excess of 10. This will lead to a blockier arrangement of monomers in the copolymer, which could yield a material with multiple glass transition temperatures. An alternative possibility is that the PEC element of the part has one T_{g} that must be surpassed before the mobility of the reactive diluent is sufficient for domains rich in that material to undergo their own segmental motion, leading to two transitions that have significant overlap.

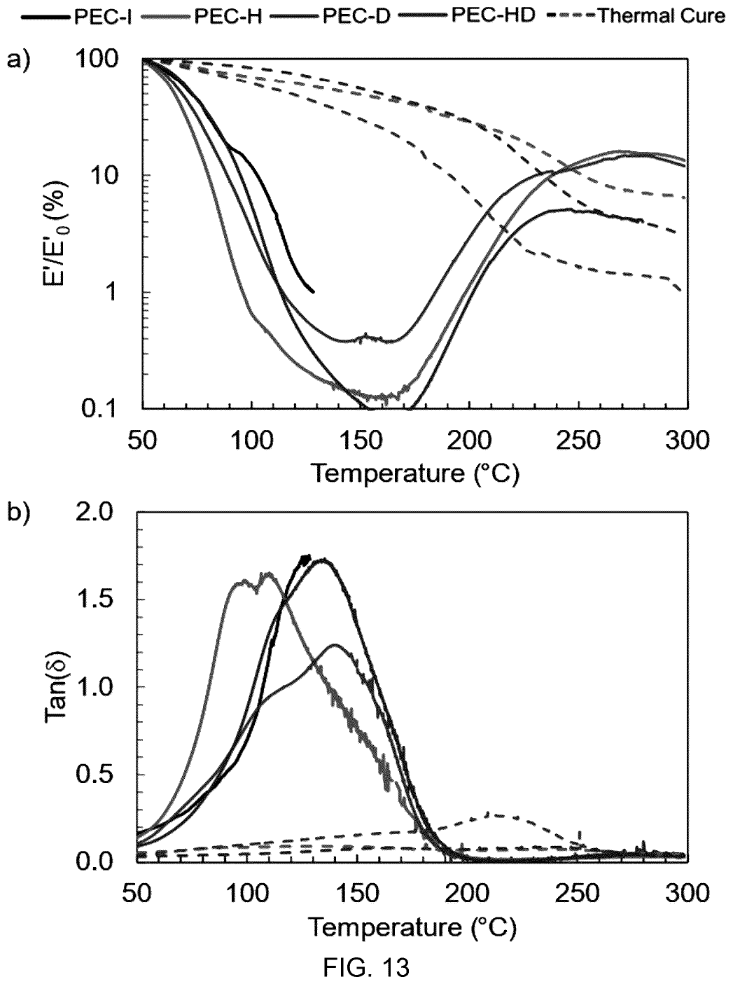

2.4 Water Exposure and Uptake of Printed Parts. Our previous work on 3D printed polyelectrolyte photopolymer complexes highlighted the tunable swelling behavior of photoPECs printed with and without a covalent crosslinker such as poly(ethylene glycol) diacrylate. While these properties are unique, the softening and dimensional changes of those parts rendered limited the engineering applications of photoPECs as a class of material. The DMA data presented previously in FIG. 11 and FIG. 12 demonstrate materials that are stiff enough for engineering applications (particularly when thermally crosslinked). The four sets of photoPEC parts were also subjected to water exposure, and the swelling was inferred by weighing the parts after removal from water. Images of these tests on as-printed and thermally cured parts are shown in FIG. 13, along with a graph summarizing the water uptake of the various parts. A cylindrical gyroid structure was chosen to provide high surface area for water exposure and to provide pores that would provide visual identification of swelling.

Inspection of the dry and hydrated parts show several interesting features. The most unique behavior among the samples studied is the “melting” of as-printed PEC-D after water immersion. Conventional PECs have been shown to exhibit hydration-dependent glass transition temperatures previously. It is possible that the PEI:poly(methacrylic acid-co-dimethyl acrylamide) complex is particularly susceptible to water content and as a result the hydrated complex has a T_{g} well below room temperature in water. Another possibility is that the dimethyl acrylamide portion is so hydrophilic that its swelling overtakes the ionic bonding of the system, which then loses its ability to maintain structure. In either case, it is clear that PEC-D has poor resistance to water exposure, the parts even fail after thermal curing when exposed to water. PEC-H and PEC-HD both behave similarly to each other, particularly after thermal curing. The hydroxyl group of HEMA may provide hydrogen bonding sites that help to exclude water and explain PEC-H's lower swelling ratio in the as-printed state. The presence of stabilizing hydrogen bonding from HEMA is balanced by the hydrophilic nature of DMAAm and results in preservation of the structure but higher overall swelling percentage for PEC-HD.

The thermally cured PECs all show similar swelling ratios in FIG. 13b, suggesting that some baseline of water absorption is to be expected from any material printed from polyelectrolyte chemistry (which is nearly universally polar and hydrophilic). This highlights the potentially significant impact that initiator identity has on not just the absorptive properties of a resin but also on the mechanical durability of a printed part.

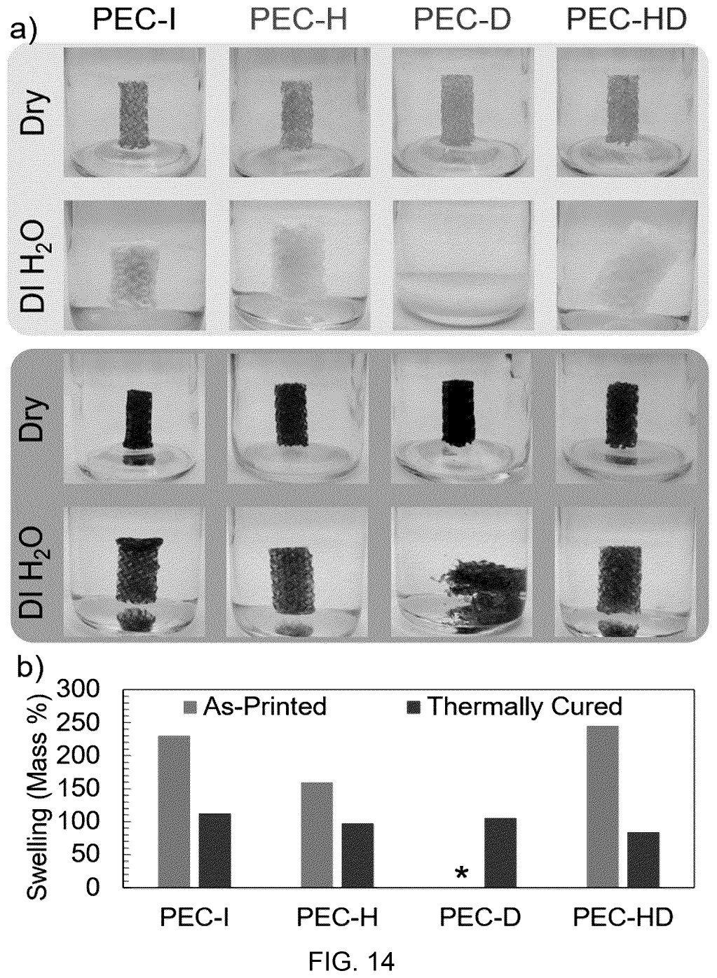

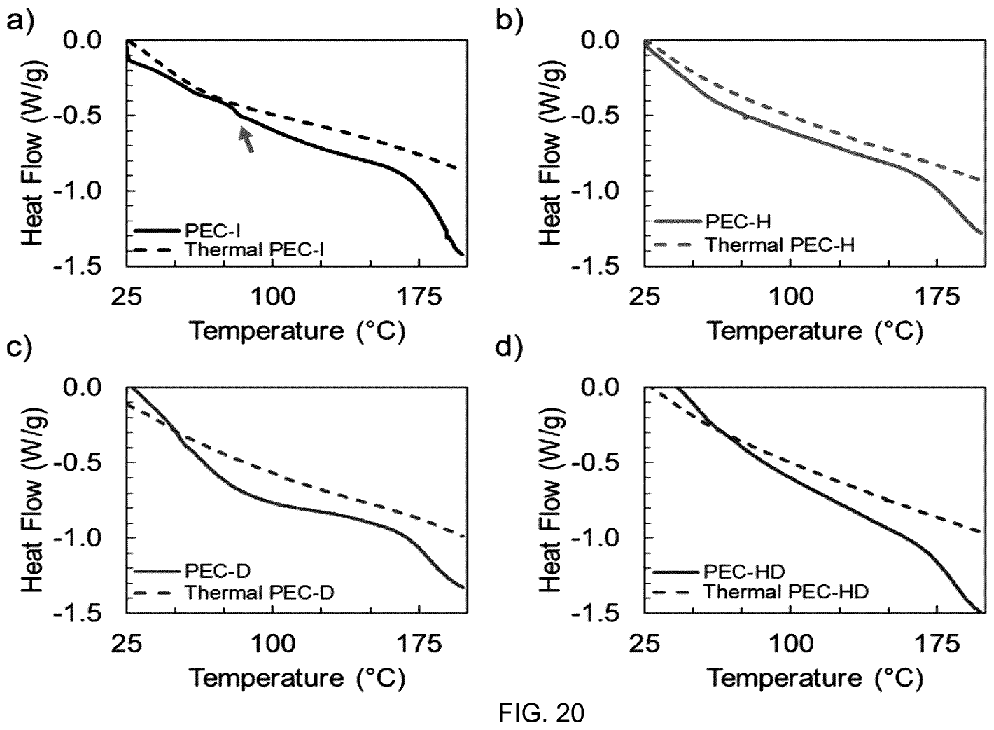

2.5 Microscopy of Printed Parts. Printed PEC-I was observed to quickly lose optical clarity and surface finish within days of ultraviolet postcuring. Optical microscopy of printed rods showing this are shown in FIG. 14a. PEC-H and PEC-HD showed the best surface finish/optical clarity. Paired with their greater storage modulus and better resistance to swelling, they represent a large step forward in the development of printed polyelectrolyte photopolymer complexes with potential for useful engineering applications. The fractured surface of the rods were subsequently analyzed by scanning electron microscopy (SEM) to look for evidence of porosity, and the acquired image for PEC-I is shown in FIG. 14b (other SEM images are available in FIG. 20). While the cracking in the surface seems to generally correspond to the surface finish of the printed parts, there is no obvious porosity visible in electron microscopy. Thus, the poor optical clarity is a result of more macroscopic phenomena and is perhaps a consequence of a unique interaction between the low-solids resins and the conversion gradients inherent to photopolymer additive manufacturing. More subtle potential reasons may be related to the lower overall degree of polymerization for PEC-I since the monomer:initiator ratio is higher in all reactive diluent resins.

3. The properties of polyelectrolyte photopolymer complexes were improved through the addition of hydroxyethyl methacrylate and/or dimethyl acrylamide as reactive diluents. The photochemical properties of the resin are controlled primarily by the PEC and initiator. All studied reactive diluent-containing resins exhibit similar processing parameters. Incorporation of reactive diluents yielded parts with significantly improved mechanical properties as compared to the first printed polyelectrolyte photopolymer complexes. The thermomechanical properties and hydrophilicity of the printed parts varied as a result of the reactive diluent(s) utilized. Thermally-driven amidization further improves modulus in these materials, and the mechanical reinforcement of a thermally crosslinked polyelectrolyte complex was monitored in-situ for the first time. The ability to spatially and thermomechanically control polyelectrolyte materials promises to widen their application space and represents a significant leap forward in the study of polyelectrolyte complex processability.

### 4. Experimental

4.1 Materials. Polyethylenimine (PEI, Mn=600 g/mol), hydroxyethyl methacrylate (HEMA, 97%), dimethyl acrylamide (DMAAm, 99%), and diphenyl(2,4,6-trimethylbenzoyl)phosphine oxide (TPO, 97%) were purchased from Sigma Aldrich (St. Louis, MO, USA). Methacrylic acid (MAA, 99%, stabilized with 100 ppm to 250 ppm hydroquinone or 4-methoxyphenol) was purchased from Fisher Scientific (Pittsburgh, PA, USA). Isopropanol (technical grade) was purchased from Rocky Mountain Reagents (Golden, CO, USA). Homopolymers of HEMA and DMAAm were synthesized for thermogravimetric analysis. A solution of ≈5 g containing TPO (2% by mass) in the reactive diluent in question was added to a scintillation vial and placed sideways with a cap on an Anycubic Ultra (Anycubic) and irradiated for 600 s using the “test exposure” feature of the printer that illuminates the entire build area. Unreacted monomer/photoinitiator were poured off and the polymer was oven dried for 48 hours prior to being scraped off of the side walls of the vial for analysis.

4.2 Formulation and Printing. Resins were prepared in the ratios shown in FIG. 7. Resins were prepared by dissolving TPO in MAA, followed by addition of the reactive diluent(s) or IPA. After dissolving on a stir plate, the bottle of resin was placed in a cold tap water bath and allowed to continue stirring. PEI was added slowly to mitigate evolved heat. Once the resin was fully prepared, it was removed from the bath and allowed to stir as it returned to room temperature prior to printing.

An array of part files were placed in the Photon Workshop software (Anycubic) and were sliced to 100 μm thick. Parts included bars for dynamic mechanical analysis that were (55×15×2) mm³ with the smallest face on the build plate as well as 25 mm tall cylinders 12.5 mm in diameter that were latticed with the Walled TPMS function in nTopology (nTopology, New York, NY, USA) using the gyroid fill with the cell size set to 5 mm in all directions with a 0.25 mm wall thickness. Prints were done on an Anycubic (Shenzen, China) M3 LCD printer with an array of nominally 405 nm LEDs that was measured to have a power output of 2.32 mW/cm² using a PM-100D power meter (Thor Labs, Newton, NJ, USA). Isopropanol-containing resins were printed with a 75 s base layer cure time for the first 4 printed layers to improve adhesion to the build plate, with subsequent layer times set to 5.25 s. Reactive diluent-based resins were printed with four 45 s base layers and 3 s for all other layers. Between deposited layers, the build plate was lifted 6 mm (0.5 mm/s for isopropanol resins, and 3 mm/s for all others) to release the cured layer from the window material, followed by lowering 5.90 mm to begin the next layer print sequence.

After prints were complete, parts were allowed to drip excess resin for 15 minutes under the UV-protective plastic casing of the printer. Parts were then carefully detached from the build plate with a razor and then post cured in a UV chamber (ECE 2000 Flood, Dymax, Torrington, CT, USA) with a measured broadband light output of 86 mW/cm² for 10 minutes on each side. In parts that were thermally post cured, they were placed in an open glass container in an 80° C. oven, which was then warmed to 180° C. over the course of approximately 30 minutes. Parts were held at this temperature for 20 hours, at which point the oven temperature was lowered to 150° C. for 4 hours prior to removal of the parts and storage at room temperature before testing.

4.3 Working Curve Measurements. Working curves were produced by inputting a .STL file of an array of sixteen 1 mm×1 mm rectangles of heights ranging from 50 μm-800 μm. This file was sliced to 50 μm layers and “printed” while a methacrylate-functionalized glass slide was placed on the build plane of projector-based 405 nm Anycubic Ultra 3D printer (Anycubic) and topped with about 3 mL of resin. All slices were irradiated for 2 s each, yielding 16 regions that received incrementally larger light doses from 4.25 mJ/cm² to 68 mJ/cm². The heights (cure depths) of the 16 regions were measured with a Mitutoyo VL-50A Litematic low force micrometer (Mitutoyo America, Aurora, IL, USA). The plot of cure depth vs exposure dose was plotted according to the Jacobs equation to generate a working curve.

4.4 Thermal and Mechanical Characterization. Part sections were subjected to thermogravimetric analysis in a Libra 1 thermogravimetric analyzer (Netzsch, Burlington, MA, USA) under an air atmosphere with a gas flow rate of 40 mL/min. Printed parts were subjected to a 10° C./min temperature ramp. Differential scanning calorimetry was performed on a Q200 differential scanning calorimeter (TA Instruments, New Castle, DE, USA). Approximately 3 mg samples were equilibrated at 25° C. and subjected to a single heating cycle to 200° C. at a rate of 5° C./min. A single heating cycle was used because of the irreversible amidization reaction that occurs between 150° C. and 200° C. Mechanical analysis was performed on a Q800 dynamic mechanical analyzer (TA Instruments, New Castle, DE, USA) with the dual cantilever bending clamp (spacing=35.0 mm). Samples were subject to 1 Hz oscillation with a 15 μm strain amplitude as samples were first equilibrated at 50° C. for 3 minutes and then heated to 300° C. at a rate of 2° C./min.

4.5 Spectroscopy and Microscopy. UV/Visible spectroscopy was performed on a Nanodrop-One variable pathlength spectrophotometer (ThermoFisher, Madison, WI, USA). One drop of pure resin was placed on the pedestal and analyzed with a 200 μm pathlength by setting the instrument's analytical wavelength to 385 nm. Fourier Transform Infrared Spectroscopy (FTIR) was performed on a Nicolet 4700 FTIR spectrometer (ThermoFisher, Madison, WI, USA) with an attenuated total reflection attachment. To improve resolution, analyzed parts were ground into a fine powder in a mortar and pestle prior to analysis.

Optical microscopy was performed on a Keyence VHX 600 Microscope (Osaka, Japan). Scanning electron microscopy was performed in a LEO 1525 SEM (Zeiss, Dublin, CA, USA) with an accelerating voltage of 5 kV on samples that were coated with Pd for 240 s in a sputter coater (SPI Supplies, West Chester, PA, USA).

4.6 Swelling and Dissolution of Printed Parts. Latticed cylinders were conditioned at ambient conditions for at least 1 week prior to immersion in 100 mL of deionized water. Prior to immersion and after 24 hours of immersion, parts were weighed to determine the weight change caused by water uptake. Parts were photographed prior to immersion and after 24 hours.

### Example 2

Sustainable Additive Manufacturing of Polyelectrolyte Photopolymer Complexes

Polyelectrolyte complexes (PECs), assemblies of oppositely charged polymers with powerful properties and wide-ranging applications, are currently not melt-processable via any conventional means and have been limited commercially to applications only as coatings. Here, a unique strategy of pairing a polycation with an oppositely charged photopolymerizable monomer is employed. Vat photopolymerization of this mixture yields 3-dimensional spatial control over PECs for the first time. The properties of these 3D printed PECs are evaluated and are found to be similar to conventionally studied PEC materials. The water-sensitivity of the PEC parts is adjustable through the incorporation of a small amount of a hydrophilic covalent crosslinker, highlighting potential future applications of these materials in 4D printing. Finally, the upcyclability of the additively manufactured PECs is demonstrated through the dissolution of a printed part and its incorporation into virgin resin to yield a part composed of partially recycled material. This chemistry has the potential to dramatically expand the application space of PEC materials and is a step towards a more circular economy for the field of additive manufacturing.

Polyelectrolyte-based materials of a composite formed by a pairing of two oppositely charged polymers possess properties that make them useful in fire protection, food packaging, drug delivery, antifouling, insulation, and more. They are very popular materials because they can be processed in aqueous solvent, are often environmentally benign, and sometimes are bio-based and/or biodegradable. While impressive, the application space of polyelectrolyte materials is limited by the challenges presented in their processing. Polyelectrolyte complexes (PECs) are bulk assemblies of oppositely charged polymers, where the sites of interaction between the two species creates a physical crosslink. These physical crosslinks give rise to unique phase behaviors, ultraviscosity, and a response to salinity that mimics the thermoplastic response to temperature. Due to the dynamic nature of these ionic bonds, polyelectrolyte complexes possess unique capabilities like recyclability and self-healing that make them very attractive as compared to more conventional polymers. The unique nature of PEC bonding gives rise to an incompatibility with melt processing, making their processing extremely challenging. As a result, PECs are typically used as coatings where spatial control is only afforded in one dimension (i.e. thickness of the coating) via layer-by-layer assembly.

Despite the lack of melt processability, progress in 2D processing of PECs has been achieved by manipulating the flow-ability of the materials via compositional variation. The thermal transition temperatures of PECs (e.g. glass transition T_{g}) can be tailored by PEC salinity and water content. In the last decade, salinity changes have enabled extrusion of PECs. While the advent of extrusion has allowed more facile study of the properties of bulk PECs, it has yet to lead to many practical applications outside of compounding PECs into thermoplastics. Despite its early promise as a new means of processing PECs, this form of processing has largely been neglected. Relatedly, the success with extrusion of 2D profiles has not led to adaptation of 3D processing techniques such as injection molding. There is still an outstanding need for the development of 3D processing techniques for PECs to enable more widespread use of these technologies.

Additive manufacturing (AM), also known as 3D printing, has seen increased popularity both industrially and in academics owing to its paradigm-shifting change of the manufacturing process. In particular, vat photopolymerization (VP) has seen significant growth due to its vast manufacturing potential and wide variety of compatible chemistries. There are several forms of VP additive manufacturing, but one commonality to all techniques is the formation of solid objects by exposing certain regions of a liquid resin to patterned light. The solidification process is driven by photopolymerizations of mono and/or multifunctional monomers into polymers, causing gelation through the formation of chemical crosslinks. Complex parts are grown layer-by-layer via lifting of a freshly-solidified layer, allowing unreacted resin to flow under the part and be subsequently exposed to a new light pattern.

Photopolymerization has been used to polymerize two-dimensional PECs and PEC coatings, but only polyelectrolyte homopolymers (which have limited practical applications because they irreversibly dissolve in water), not complexes, have been produced via VP. There have not yet been any reports of 3D printed PECs by any AM method. Here, a VP-AM technique is demonstrated which yields the ability to generate controlled three-dimensional structures for PECs of photopolymerized poly(methacrylic acid) (PMAA) and the polycation polyethylenimine (PEI) for the first time. Unlike traditional VP resins, this PEI:PMAA resin forms parts on the basis of reversible physical crosslinks instead of permanent covalent ones. This yields photopolymerized parts that can have tunable swelling properties in water (via the incorporation of a covalent crosslinker) and that can be redissolved after pH adjustment and incorporated back into virgin resin to be printed again. The facile upcyclability of the printed PECs puts these materials in very rare company among existing photopolymer resins which typically have little-to-no potential to reuse printed parts. This novel application of polyelectrolyte chemistry offers promise for a more sustainable and circular AM economy in addition to unlocking novel 3D printing chemistries that could enable materials which are intrinsically flame retardant, biocompatible, antifouling, stimuli responsive, or a combination therein.

2.1. Polyelectrolyte Photocomplexation

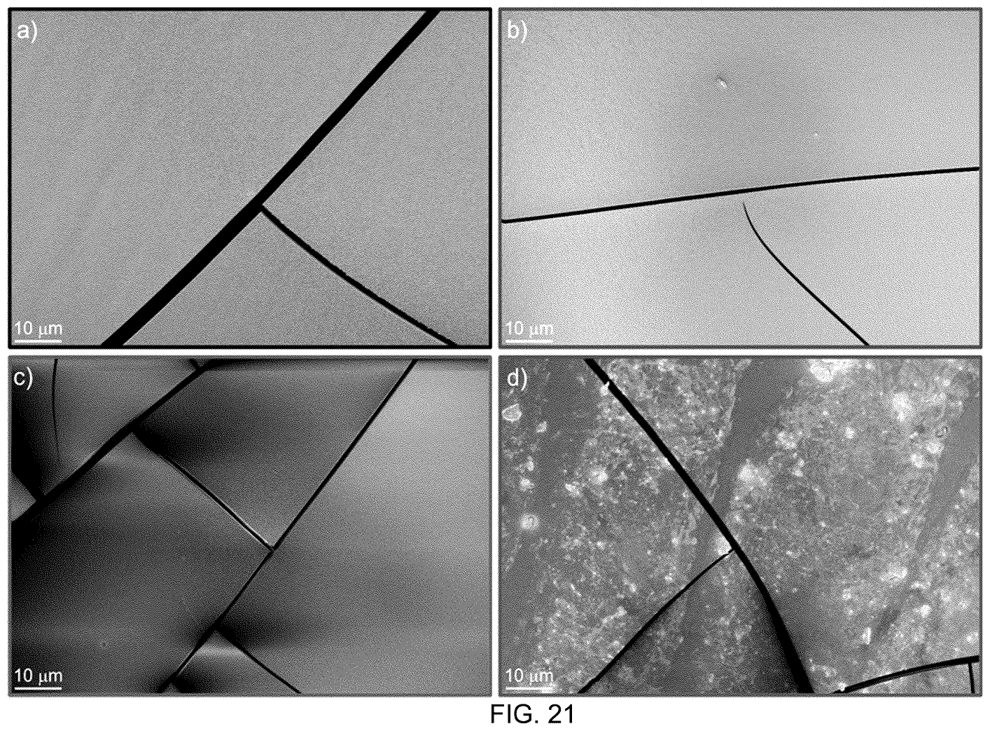

The process of photopolymerization of methacrylic acid followed by complexation with PEI is shown in FIG. 21. A stoichiometric mixture of neutral methacrylic acid (MAA) and PEI are dissolved in isopropanol along with a photoinitiator (BAPO) to form the photoactive resins. The PEI:MAA:BAPO molar ratio of 105:105:1 (the molar mass of PEI's aziridine repeat unit was utilized) was held constant across all studied resin formulations regardless of overall concentration. Because of the acid-base reaction between PEI's repeat units and MAA, the monomers are already associated with the oppositely charged polymer in solution prior to polymerization. Other acid species, such as acrylic acid, are known to polymerize faster in their deprotonated state, so this pre-charged system may also increase the reaction rate. Gelation during printing is accomplished by the complexation of the PEI with the photopolymerized PMAA, rather than by covalent crosslinking more typically seen in VP (FIG. 21b). A relatively low molecular weight PEI (Mₙ=600 g mol¹) was used to minimize resin viscosity and maximize solubility. Resins composed of pure PEI:MAA rapidly became too viscous to use in a printer, and the resultant assembly could not be dissolved. The addition of isopropanol (IPA) as a solvent ensures a suitable viscosity for printing. Other stereolithography resins have been developed which make use of ionic coordination via acid-base reactions, but necessitated lower solids content than the PEI:PMAA resin that is used here (66.5 wt % for the highest concentration resin). After mixing, the PEI/MAA/IPA resins are shelf-stable so long as they are kept away from light.

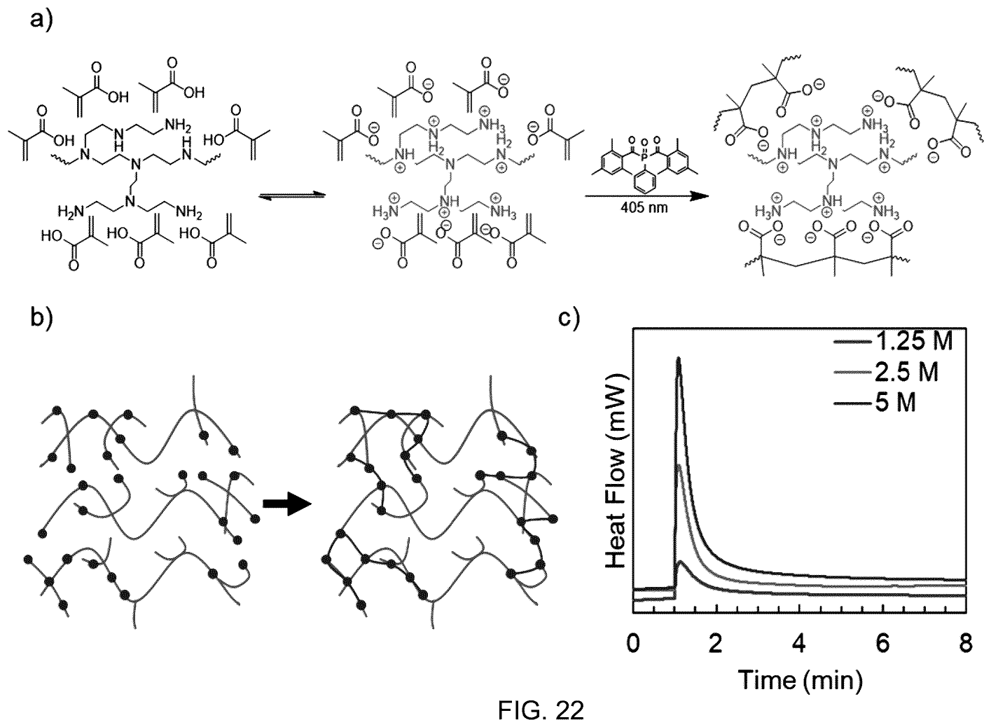

Differential scanning calorimetry under a UV light source (PhotoDSC) was utilized to study the rate of the polymerization reaction of MAA. This is shown in FIG. 21c, with the integrated peaks summarized in FIG. 22. The width of the peaks in the plot shows that the reactions take slightly longer to complete as the concentration of the resin increases, likely because the viscosity of the solution increases and slows the rate of MAA propagation. The heat evolved from the polymerization (DHᵣₓₙ) measured from PhotoDSC can be used as a proxy for extent of reaction by comparing it to a calculated heat of polymerization (DH_{polym}) for a pure material (an example calculation for the 5 M resin is available in the SI). From the tabulated data, it can be seen that heat of reaction is nearly linearly proportional with resin concentration and that extent of reaction is consistently just above 50%. Deviations from linearity in this system could be explained by a more rapid evaporation of solvent out of the resin in the more exothermic systems providing a lower apparent enthalpy. Measured conversions of <60% in PhotoDSC are relatively low as compared to most photopolymer resins. However, the effective functionality of ionically associated PEI:MAA will be extremely high. The number average degree of polymerization of PEI is around 14, and it can be safely assumed that many of those repeat units at any given instant are coordinated with a methacrylate anion. High levels of functionality lower the conversion required to achieve gelation, and as a result parts are able to be printed even with this apparently lower conversion percentage.

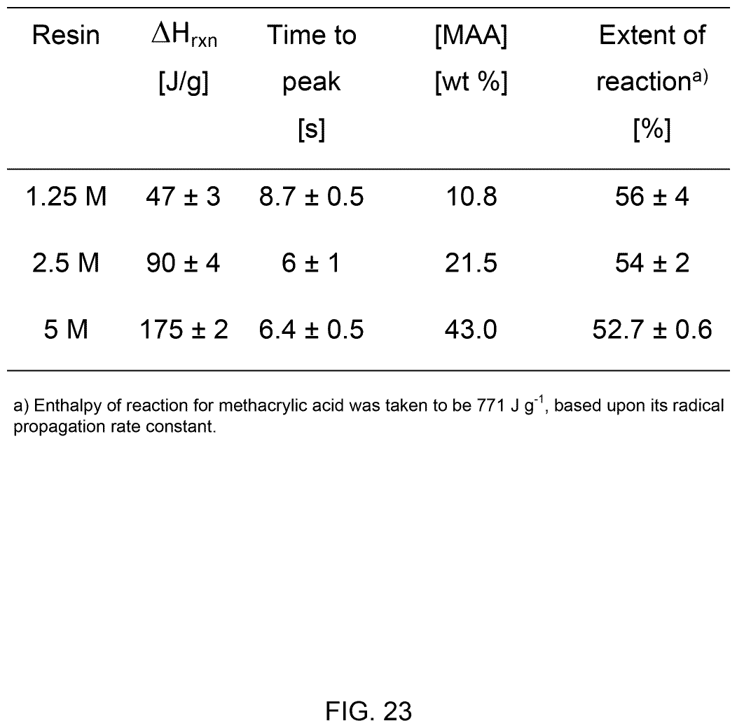

To assess the ability of the PEC resins to print via layered VP-AM, working curve measurements were performed. Working curves measure the depth of a cured layer versus light exposure dose to determine critical exposure dose for gelation and depth of light penetration. The working curves for the PEC resins were determined by exposing PEC resin to light doses (from a ca. 2.3 mW cm⁻² light source) ranging from 4.6 mJ cm⁻² to 74 mJ cm⁻² with a 1 mm×1 mm illumination pattern and measuring the heights of the resultant pillars (FIG. 23). To ensure substrate adhesion for the measurement, the pillars were polymerized on methacrylate-functionalized glass slides. The dramatically different critical dose for gelation highlights the importance of polyelectrolyte concentration on its ability to photocomplex. The 2.5 M resin requires a more than 3-fold light dose (by comparing E_{c}, the critical light dose) as compared to the 5 M resin just to reach the gel point. The working curve measurement differs from the actual printing process in that there is no vertical confinement from a build plate (since it is cured to a glass cover slip) and the cured material does not need to survive the stress of the build plate lift step. Thus, printing parameters cannot be directly extracted from the working curve. For example, delivering a light dose corresponding to a 100 μm cure depth (a roughly 2 s exposure on the printer studied) on the working curve does not yield enough solid to adhere to the build plate. Instead, 5.25 s layer times (≈12 mJ cm⁻²) were utilized, which the working curve would predict to generate a layer thickness of ≈365 μm, to print 100 μm layers with the 5 M PEC. This disparity may be a result of the lack of oxygen inhibition (i.e. the termination of growing chains by oxygen dissolved in the resin) at the substrate-resin interface when making the working curve on glass as opposed to the fluorinated ethylene propylene film in the LCD printer. The need to polymerize past the cure depth could also be a consequence of needing enough interlayer strength for the material to adhere to the build plate or the previously polymerized layer.

The three studied resins exhibit significantly different working curves, with the 2.5 M resin exhibiting a much shallower response in cure depth to the delivered light dose than the 5 M resin. The 1.25 M resin did not form any solid at all. According to the curve fit equations, it would take nearly 500× longer per layer to print the 2.5 M PEC (assuming a cure depth of 365 μm from the working curve universally correlates to a successful 100 μm layer). Typically, photopolymer additive manufacturing processes set layer times as close as possible to the minimum network formation time to improve printing throughput and avoid lateral over-polymerization. It has been shown recently that, in thermally initiated polymerizations of an anionic monomer in the presence of a polycation, the size of the PEC aggregates formed scales dramatically with concentration of the polyelectrolyte. Similar aggregates may form prior to the formation and precipitation of a PEC network in this printing process. As a result, maximizing solids (i.e. nonsolvent) content of a VP resin is critical to print success.

Photo rheology can be used to understand the kinetics of photocuring and the gel point of a given resin. The gel point is of particular interest in VP printing because this point can indicate when a layer is solid enough to continue the printing process. The gel point is typically defined as the crossover in the storage and loss moduli of a material (i.e. when the loss tangent, which is the ratio of loss modulus to storage modulus, drops below 1) and the material transitions from a liquid-like solution to an elastically dominated gel-like semisolid. Interestingly, as shown in FIG. 23b, the 5 M resin begins with a loss tangent <1 from the onset of study, while the lower concentration resins are of sufficiently low viscosity to approach the lower limit of torque sensitivity of the rheometer prior to the beginning of irradiation. The initial tan(δ) values less than 1 prior to polymerization that were observed for the 5 M resin may be due to very high intermolecular forces between the salted PEI:MAA units, leading to more elasticity at the 10 Hz frequency used for the photo rheology experiments. The “spike” in tan(δ) for the 5 M resin shortly after the onset of irradiation is uncommon in most photopolymer resins. The brief increase in tan(δ) before it begins to decline indicates a rearrangement of the forces that cause the 5 M resin's initial elasticity. The early phases of polymerization may create localized heat that decreases the viscosity of the medium before the ionically bound network begins to form. A similar “spike” is also observed in the plot of storage modulus but occurs farther after the initiation of polymerization than the peak in tan(δ) (FIG. 23c). The peak appears several seconds after the onset of UV irradiation, as the storage modulus nears its apparent plateau. This could be a result of the ultraviscosity of PECs (where viscosity ˜M_{w}⁵) dramatically increasing the modulus of the material as the initial network forms before slippage across the ionic bonds leads to relaxation and a plateau in the shear modulus. Only the two resins which formed solid in the working curve experiment exhibited this spike in G′, further suggesting a critical concentration required to form a network. The plot of tan(δ) versus time also demonstrates the difference in curing kinetics between the three resins, as the loss tangent of the 5 M resin falls significantly faster than the other two.

2.2. Additive Manufacturing of Polyelectrolyte Complexes

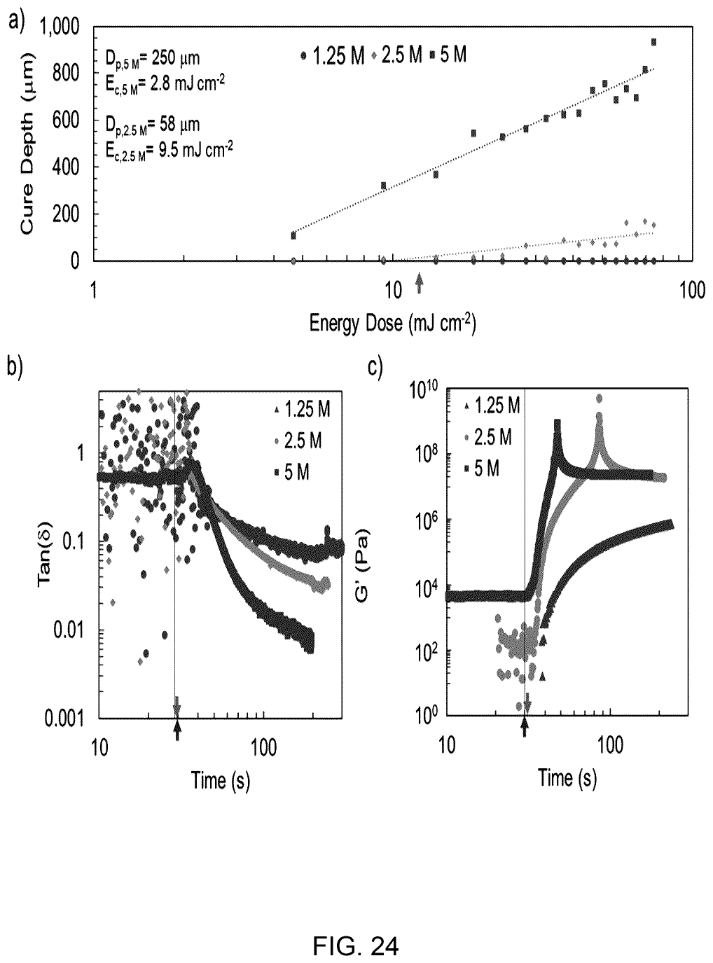

Photographs of parts printed from the 5 M resin can be seen in FIG. 24a. The boat structure demonstrates some important properties of this printing system. First, it can be used to print overhanging features, such as the steering wheel, along with more robust overhanging structures like the roof. Additionally, the PEC parts very closely match the programmed dimensions for printing. Cylinders printed for mechanical property and swelling measurements exhibit a volume shrinkage <5% compared to the programmed dimensions. A long-hypothesized issue with the additive manufacturing of solid PECs was their dimensional instability when exposed to the aqueous salt solutions required to process them. Unlike conventional PEC processing, the studied resins here are prepared in isopropanol. Organic solvents have been shown to have a desiccating effect on PECs, and do not swell dry PECs appreciably. To further understand the interaction of water with additively manufactured PEC parts, printed items were subjected to thermal curing conditions. In other polyelectrolyte systems with similar chemistries this form of thermal treatment leads to the formation of amide and/or anhydride bonds between the PEI and PMAA. The introduction of covalent crosslinking to these systems is hypothesized to provide improved part durability and increased stiffness.

The thermal-crosslinking has a clear effect on both the color and optical clarity of the printed parts, as evidenced by the appearance of the crosslinked boats in FIG. 24a. Microscope images comparing the as-printed and thermally-cured PEC parts are shown in FIG. 24b. It is clear from these images that the elimination of water from the thermal-crosslinking process does not visibly alter the dimensions of the part. However, the individual printed layers stand out more sharply in the thermal-crosslinked part. It is likely that these lines are “smoothed out” by the as-printed PEC's higher hydrophilicity as the part absorbs a small amount of moisture from the air. A comparison of as-printed and thermally-cured PECs when exposed to water is shown in FIG. 24c. While the macroscopic swelling of the thermally cured system is lower than in the as-printed system, the part quickly fails and breaks into several pieces. This swelling and failing phenomenon is not observed in extruded traditional PECs. Since the amine groups of PEI are coordinated to MAA through an acid-base interaction prior to printing, it is possible that this creates a more segmented network that could cause fragility of this system when exposed to water. This failure may also be a consequence of the lower molar mass of PEI that was used (Mₙ=600 g mol⁻¹) because of the unprintable viscosity arising from a more commonly used molar mass of PEI (>10,000 g mol⁻¹). A lower molar mass would yield fewer ionic crosslinks to hold the printed object together and a less interconnected network.

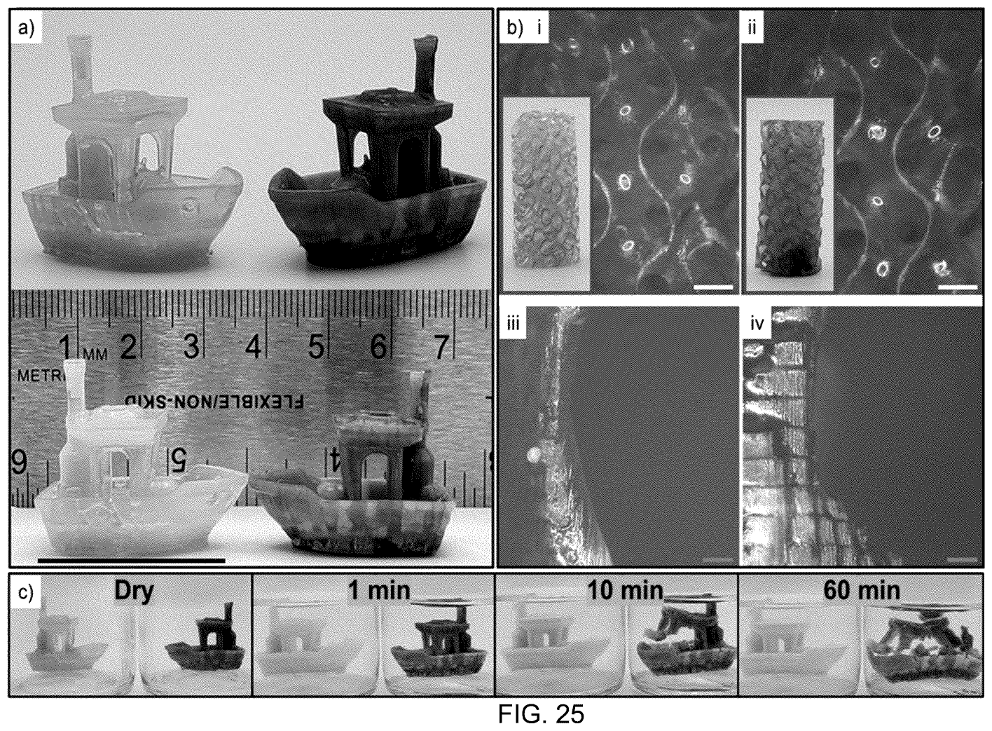

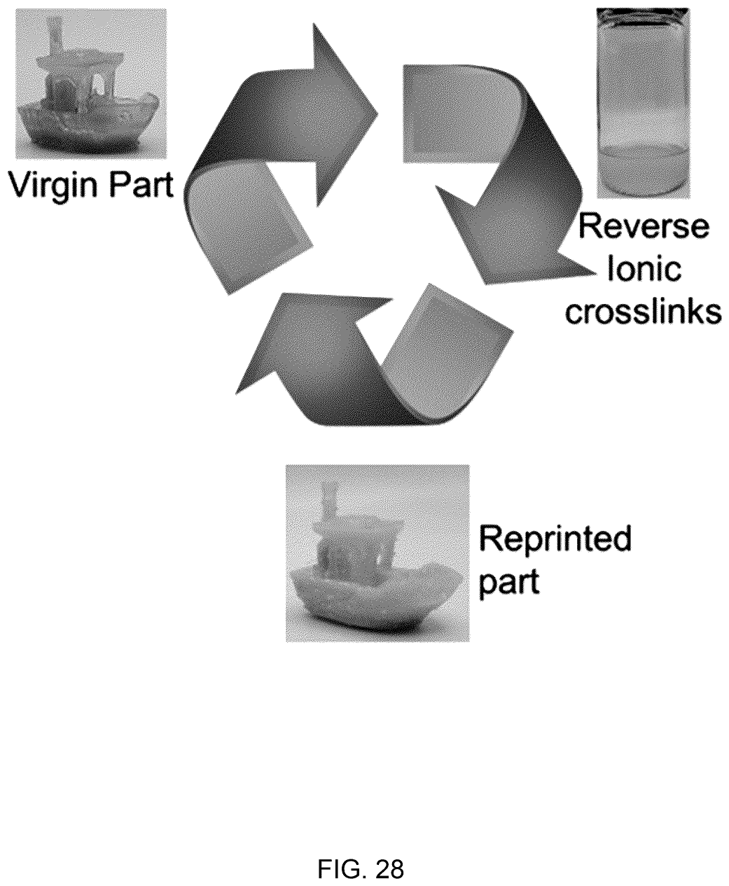

In order to attain a more cohesive network, a small amount (1 wt %) of poly(ethylene glycol) diacrylate (PEGDA) was added into the 5 M PEC resin. The incorporation of PEGDA provides a small amount of covalent crosslinking to the PMAA and was hypothesized to be capable of providing a more coherent networked structure capable of excluding water once thermally cured. The PEGDA-PEC did not alter the print parameters from the native 5 M PEC resin, which can be seen by comparing the working curves of the 5 M resin with and without PEGDA (FIG. 28). When printed with the established parameters for the 5 M PEI:MAA resin, the PEGDA-PEC resin yielded parts with good surface finish, which can be seen in FIG. 25a. The parts appear more transparent than the parts printed from the 5 M PEC resin. This may be due to the PEGDA improving the interfaces between PEC domains leading to less light scattering.

The addition of PEGDA did not serve to significantly improve the durability of thermally cured parts in water, as shown in FIG. 25b. The addition of the covalent crosslinking in addition to the ionic crosslinking caused the resin to be significantly more sensitive to water. Parts printed for compression testing from the PEGDA-PEC resin swelled to over double their volume after exposure to DI water overnight (FIG. 25c) while the compression specimen printed from the 5 M resin swelled by only ˜40%. The extreme increase in water uptake is likely a result of PEGDA's highly hydrophilic nature. For both the 5 M resin and the PEGDA-PEC resin, the thermal cure reduces the susceptibility of the parts to swelling. However, without the presence of PEGDA the thermally cured compression samples consistently failed during water immersion, with only a single sample surviving the water exposure for dimensional measurement and compression testing.

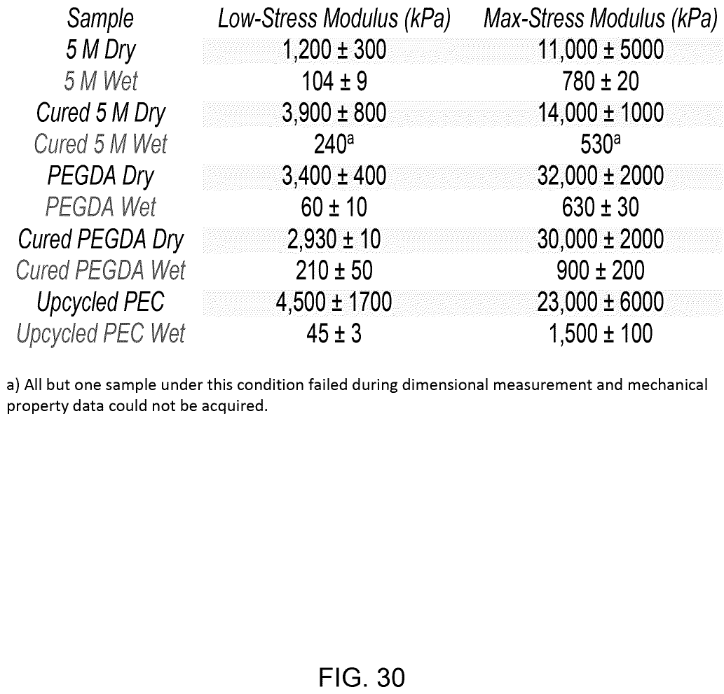

Representative compressive stress-strain curves are shown in FIG. 25d and FIG. 25e, with tabulated modulus values in FIG. 30. In all cases except for the dry PEGDA-PEC resin, the parts become stiffer after thermal curing. It is notable that there is considerable deformation of the dry 5 M resin parts in the early phases of compression testing. This is likely due to the presence of collapsible voids in the structure due to the presence of solvent in the resin. A thermal cure or the presence of PEGDA makes these pores strong enough to resist collapse during compression testing. Pores could be avoided in future iterations of this resin by incorporating a reactive diluent. The stress-strain curve in FIG. 25e highlights once again the extreme sensitivity of the PEGDA-PEC parts to the presence of water, with a compression of >80% possible without failure. The biocompatibility of many PECs and this adjustable dimensional change in aqueous environments gives additively manufactured PECs potential uses in regenerative medicine as this photopolymerization technique becomes better understood in the future. Further studies could also reveal means of programming differential dimensional change into the printing process and yield 4D printing of these materials.

2.3. Upcycling and Reprinting of Polyelectrolyte Complexes

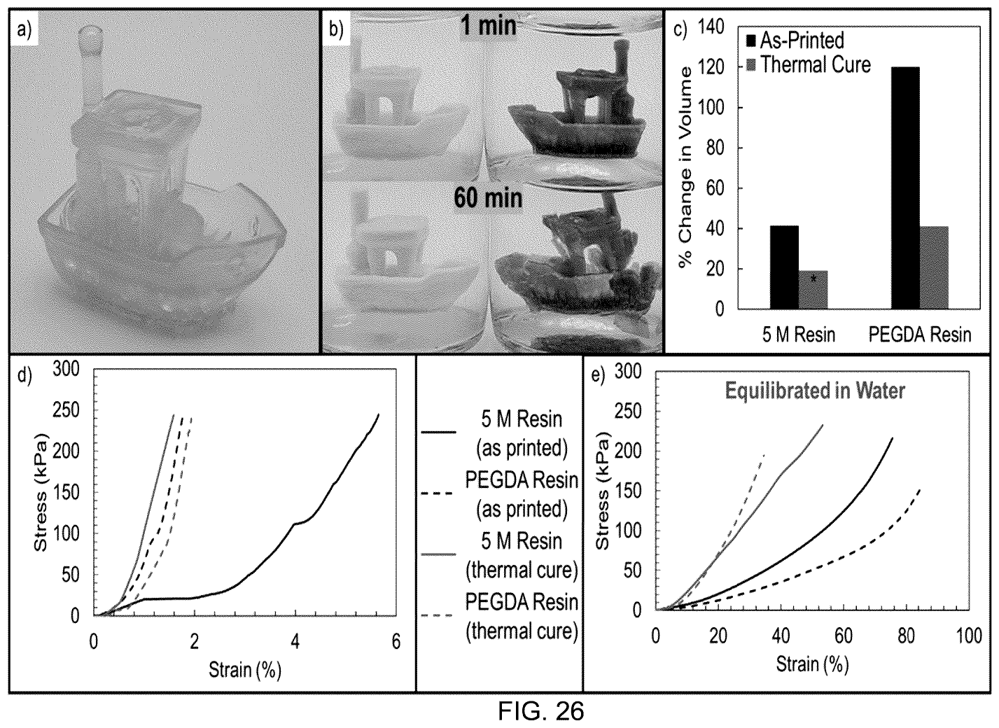

Polyelectrolyte complexes are well known for their dynamic bonds, which can be influenced by hydration and salt to affect their mechanical properties and phase behavior. The reversibility of their ionic interactions has led to functional PEC hydrogels and coatings being used as self-healing materials. Owing to the lack of conventional covalent crosslinkers, additively manufactured polyelectrolyte homopolymers have been shown to be water soluble. As shown in FIG. 24 and FIG. 25, printed PEC parts are not soluble in water due to the ionic linkages between the chains. FIG. 26 shows that a printed PEC (without PEGDA) part can be dissolved in a basic solution to reverse its ionic crosslinks. Exposure to a 1 M NaOH solution overnight yields a homogenous solution. This is done by deprotonating the PEI groups, yielding a mixture with highly charged PMAA and little-to-no charge on the PEI molecules. The printed PEC was found to be soluble while accounting for as much as 15 wt % in 1 M NaOH.

After the printed part is fully dissolved, the part solution can be reincorporated into virgin resin as a 5 wt % additive. Due to the presence of acidic protons from methacrylic acid in the virgin resin, some of the PEC precipitates in the mixed resin solution. However, it is very loosely complexed due to the high PEI:PMAA ratio leading to a low driving force for complexation. The resultant slurry can be stirred to homogeneity by hand and poured into the printer vat for reprinting. Upcycled parts are printed under the same conditions as the virgin resin and are shown in the farthest right panel of FIG. 26a. It is clear from the photos that the surface finish is poorer, likely a result of light scattering from the presence of precipitated PEC. This issue could be corrected with existing software approaches that account for the scattering of a resin during the printing process. A compressive stress-strain plot of the upcycled PECs compared to the virgin PECs are shown in FIG. 26b-c, with modulus values summarized in FIG. 30. The presence of dissolved and reincorporated PEC improves the modulus of the studied specimen, especially at lower stresses where early deformation was apparent in the virgin PEC. It is possible that in the dry case, the upcycled PEC acts as an ionically bound filler to reinforce the structure. The hydrophilic nature of the filler may lead to exaggerated softening when the material is hydrated and thus the decreased modulus observed in FIG. 26c. The ability to upcycle and reprint parts represents a step towards a more circular economy for photopolymer additive manufacturing. Presently, photopolymer resins yield highly covalently crosslinked materials which are challenging or impossible to break down over time. While the recycled content is somewhat low, the simplicity of the dissolution process (as compared to the energy and time intensive grinding that would be required of other photopolymer resins) offers promise for facile upcycling of these materials. Future work will endeavor to increase the reused fraction of these parts to enable a true chemical recycling process. The unique phase behavior of polyelectrolyte complexes offers a new avenue towards a more responsible use of resources in the additive manufacturing field.

3. Historically, polyelectrolyte complexes have only been able to be processed as coatings that effectively have one dimension of control (i.e. thickness). In this work, a polyelectrolyte complex was additively manufactured for the first time via vat photopolymerization. The printed parts are durable, and through a combination of hydration, thermal curing, and added crosslinker, have tunable dimensions and mechanical properties. Additionally, the reversible nature of the ionic bonds of polyelectrolyte complexes makes these materials uniquely suited to upcycling and reprinting, which is rare in photopolymer materials. The ability to upcycle these materials represents an important step towards a circular economy for the field of photopolymer additive manufacturing. Most importantly, this work enables future studies into the synthesis of three-dimensionally patterned polyelectrolyte complexes with the potential to yield additively manufactured parts with high biocompatibility, biodegradability, and fire resistance. The demonstrated responsivity to both water and pH indicates that these materials also hold promise in the emerging field of 4D printing.

### 4. Experimental Section

4.1 Materials and Resin Formulation

Branched polyethylenimine (PEI, Mₙ=600 g mol⁻¹, M_{w}=800 g mol⁻¹), phenylbis(2,4,6-trimethylbenzoyl)phosphine oxide (BAPO, 97%), poly(ethylene glycol) diacrylate (PEGDA, Mₙ=575 g mol-1), acetic acid (glacial, ReagentPlus ≥99%), 3-(trimethoxysilyl)propyl methacrylate (98%), and sodium hydroxide (NaOH, BioXtra ≥98%) were purchased from Sigma-Aldrich (St. Louis, MO, USA). Methacrylic acid (MAA, 99%, stabilized with 100 ppm to 250 ppm hydroquinone or 4-methoxyphenol) was purchased from Fisher Scientific (Pittsburgh, PA, USA). Isopropyl alcohol (IPA, technical grade) was purchased from Rocky Mountain Reagents (Golden, CO, USA). All water used was deionized.

Additive manufacturing resins were nominally 5 M with respect to both MAA and PEI's repeat unit (aziridine), with a ≈105:1 MAA:BAPO molar ratio dissolved in IPA. For reference, a 5 M resin would contain 21.5 wt % PEI, 43.0 wt % MAA, and 2.0 wt % BAPO (with the balance being IPA). Resins were prepared by first dissolving MAA and BAPO in IPA. This mixture was then chilled in an ice bath while stirring. PEI was then added dropwise to mitigate the heat of solvation and the acid-base reaction that occurs between MAA and PEI. The 2.5 M resin and 1.25 M resin were prepared with 50% or 25%, respectively, of the solids used in the 5 M resin. For resins containing the covalent crosslinker PEGDA, 1 wt % of PEGDA was added in place of IPA after complete dissolution of the PEI (e.g., in 100 g of resin, 1 g of PEGDA would replace 1 g of IPA).

Parts were upcycled by preparing a solution of 15 wt % printed part in 1 M NaOH. This solution was heated in a 70° C. oven overnight, and the cooled solution was added to a batch of virgin resin at 5 wt % loading.

4.2 Part Fabrication

All parts were printed on a Photon M3 405 nm LCD printer (Anycubic) that was measured to have an optical power output of 2.3 mW cm⁻² (PM100D, Thorlabs, Newton, NJ, USA). CAD models of test specimens were sliced to 100 mm layers and exported as a print file in Photon Workshop (Anycubic). Prints were carried out with 4 initial “burn-in” layers with 75 s of irradiation to improve adhesion to the build plate, and all subsequent layers were printed with a 5.25 s irradiation time per layer. Between layers the build plate was lifted 6 mm at 0.5 mm s⁻¹ and retracted (i.e. lowered into vat to specified layer thickness) at 3 mm s⁻¹. All parts were allowed to rest in ambient conditions (21° C., 50% relative humidity, and 101.4 kPa atmospheric pressure) for at least 3 days before characterization.

Parts for compression testing and cylindrical lattices were designed in nTopology (nTopology, Inc. New York, NY, USA). Compression samples were designed as solid cylinders with a 10 mm diameter and 5 mm height. Latticed cylinders were created by using the ‘Walled TPMS’ function in nTopology on a 13 mm diameter, 25 mm tall cylinder. The gyroid cell size was set to (5×5×5) mm³ with a 0.25 mm wall thickness. Ben the Floating Benchmark (aka Benchy) was downloaded from Thingiverse. Swelling demonstrations were performed by soaking printed parts in deionized (DI) water overnight. Thermally cured parts were placed in a 100° C. oven for 8 hours, and the temperature was then changed to 120° C. for 96 hours prior to testing.

4.3 Characterization

PhotoDSC and photorheology experiments were performed on a Q200 DSC (TA Instruments, New Castle, DE, USA) and on a HAAKE MARS 60 rheometer (ThermoFisher Scientific, Karlsruhe, Germany), respectively. Each instrument was connected to an Omnicure S2000 (Excelitas Technologies, Waltham, MA, USA) broad spectrum UV curing system that was coupled fiber-optically to the instrument. The light was filtered with a 400-500 nm bandpass filter to mimic the printing wavelength of 405 nm more closely.

Samples for PhotoDSC were prepared by placing 2 mg to 3 mg of resin into the bottom of an aluminum Tzero pan (TA Instruments, New Castle, DE, USA). Due to the volatility of IPA, pieces of a glass coverslip (ca. 200 mm thick) were placed over the sample and reference pans to minimize evaporation. PhotoDSC experiments began by equilibrating the samples with a 60 s isothermal step held at 25° C. After this equilibration step, the light shutter was opened and the samples were allowed to photocure for 10 minutes before the shutter was closed. The light was run at its lowest intensity setting of 3.5 mW cm⁻² (reported by the instrument).

Samples for photorheology were prepared by pipetting resin (≈1 mL) onto the bottom stainless-steel rheometer plate. The loaded sample was then dispersed between the bottom plate and upper measuring geometry, which consisted of a 20 mm diameter exchangeable quartz glass plate and steel shaft with integrated mirror. Due to significant differences in solution viscosity, the gap between the quartz upper geometry and the bottom plate was varied between 1.2 mm (5 M) and 0.3 mm (1.25 M). The UV light source, which was mounted to the rhomeeter measuring head, was passed through a collimator and directed vertically downward through the upper glass plate via the integrated mirror. All samples were analyzed via time sweep using small-amplitude oscillatory shear with a constant strain value of 0.05% at a frequency of 10 Hz to ensure a sufficient number of data points. Samples equilibrated at 25° C. for 30 s before light exposure began. Light exposure was constant at 9.48 mW cm⁻² (measured by a power meter) until the experiment was terminated.

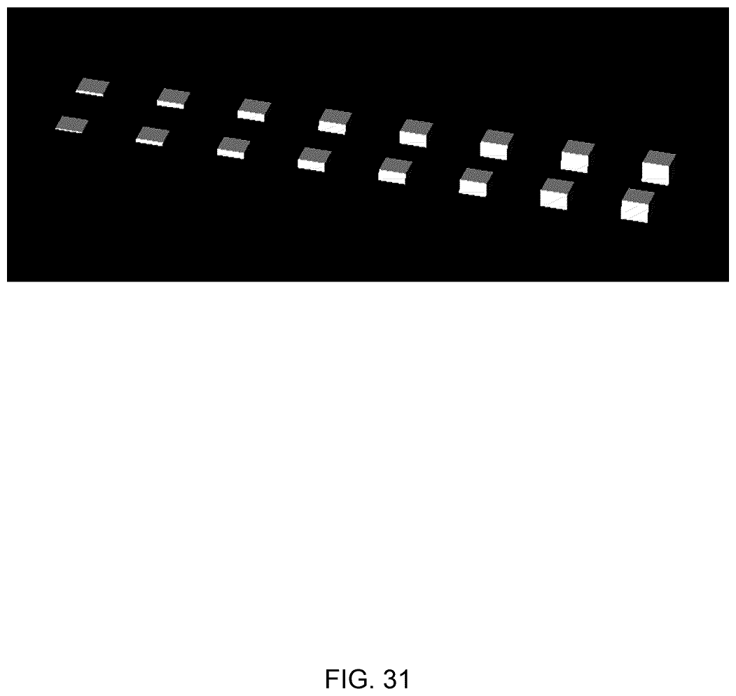

A working curve for each resin was generated by inputting a .stl file of 16 square columns that were 1×1 mm² in size. This file (FIG. 31) was sliced into 16 layers (each with one fewer square than the last) to create 16 exposure conditions. Resin was placed directly on a methacrylate functionalized glass cover slip (No. 1 Corning cover glass, purchased from Sigma Aldrich) on the printer LCD screen and the .stl file was “printed” with no build plate. Excess resin was poured off and the slides were allowed to sit at ambient conditions for 2 hours. Height of the 16 regions was measured with a VL-50A Litematic low force measurement system (Mitutoyo America, Aurora, IL, USA) to produce the measured cure depths for the working curve.

Mechanical properties were measured on a Q800 DMA (TA Instruments, New Castle, DE, USA). Cylinders (ca. 10 mm diameter and 5 mm tall) were placed in the compression clamp and a stress/strain curve was generated by measuring displacement as applied force was increased from 0 to 18 N (loading rate=1 N min⁻¹). Compressive moduli were calculated from either the first 2 N of force (low-stress modulus) or the final 2 N of force (high-stress modulus). Hydrated parts for mechanical property testing were soaked in DI water for 16 hours prior to testing and were placed in the DMA immediately after removal from water. Optical microscopy was performed on a VHX 600 microscope (Keyence, Osaka, Japan).

A polyelectrolyte complex is additively manufactured for the first time through vat photopolymerization. The mechanical properties of parts can be tuned through thermal treatment and by altering the resin chemistry. The ionic bonds which form these parts can be reversed through exposure to base and the part can be reprinted, showing promise for a circular 3D printing economy. calculation for determination of MAA conversion via photoDSC:

Conversion in the photoDSC is measured by comparing measured reaction enthalpy in the DSC to the theoretical enthalpy of reaction according to the following equation:

$$\% Conversion = \frac{Δ {H}_{rxn , measured}}{Δ {H}_{theoretical}} * 100 \% \qquad ( 1 )$$

The measured enthalpy of reaction, DH_{rxn,measured} is found in FIG. 22 and is 175 J g⁻¹ for the 5 M resin. This must be normalized for the fraction of the resin that MAA accounts for (43 wt %) according to:

$$Δ {H}_{rxn , measured} = 175 \frac{J}{g resin} * \frac{100 g resin}{43 g MAA} \approx 407 \frac{J}{g MAA} \qquad ( 2 )$$

MAA has a molar mass of ca. 86 g mol⁻¹, the results from equation 2 can be multiplied by the molar mass to obtain a reaction enthalpy of 35 kJ mol⁻¹. The literature reaction enthalpy for methacrylic acid, DH_{theoretical}, is 66 kJ mol⁻¹. Use of these two values in equation 1 yields a % Conversion of ˜53%.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive, rather the elements can be used separately or can be combined together under appropriate circumstances.

What is claimed is:

1. An additive manufacturing polyelectrolyte resin for additively manufacturing a additively manufactured article, the additive manufacturing polyelectrolyte resin comprising:
a cationic poly-ammonium electrolyte;
an anionic organic acrylate monomer;
a chemical modifier selected from the group consisting essentially of a photoabsorber and an ion dispersion solvent comprising an organic reactive diluent; and
a photoinitiator.

2. The additive manufacturing polyelectrolyte resin of claim 1, further comprising a covalent crosslinker.

3. The additive manufacturing polyelectrolyte resin of claim 1, wherein the chemical modifier is the photoabsorber.

4. The additive manufacturing polyelectrolyte resin of claim 1, wherein the cationic poly-ammonium electrolyte comprises a primary ammonium group, a secondary ammonium group, a tertiary ammonium group, a quaternary ammonium group, or a combination comprising at least one of the foregoing ammonium groups.

5. The additive manufacturing polyelectrolyte resin of claim 1, wherein the anionic organic acrylate monomer comprises an acrylate group directly attached to a carbon atom or a hydrogen atom as: 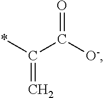
wherein * is a point of attachment for the hydrogen atom or the carbon atom to the acrylate group.

6. The additive manufacturing polyelectrolyte resin of claim 1, wherein the organic reactive diluent of the ion dispersion solvent reacts with the anionic organic acrylate monomer to form an anionic copolymer.

7. The additive manufacturing polyelectrolyte resin of claim 1, wherein the ion dispersion solvent further comprises a polar organic solvent.

8. The additive manufacturing polyelectrolyte resin, of claim 1, wherein the ion dispersion solvent disrupts agglomeration of the cationic poly-ammonium electrolyte with the anionic organic acrylate monomer in the additive manufacturing polyelectrolyte resin.

9. The additive manufacturing polyelectrolyte resin of claim 1, wherein the additive manufacturing polyelectrolyte resin is a liquid.

10. The additive manufacturing polyelectrolyte resin of claim 1, wherein the additive manufacturing polyelectrolyte resin is optically absorbent at a wavelength of light used for 3D printing or stereolithography at which the anionic organic acrylate monomer is cured when subjected to light used for 3D printing or stereolithography.

11. The additive manufacturing polyelectrolyte resin of claim 10, wherein the wavelength of light used for 3D printing or stereolithography is ultraviolet (UV) light.

12. A process for additively manufacturing an additively manufactured article from an additive manufacturing polyelectrolyte resin, the process comprising:
subjecting the additive manufacturing polyelectrolyte resin to a polymerizing light, the additive manufacturing polyelectrolyte resin comprising:
a cationic poly-ammonium electrolyte;
an anionic organic acrylate monomer;
a chemical modifier selected from the group consisting essentially of a photoabsorber and an ion dispersion solvent comprising an organic reactive diluent; and
a photoinitiator;
polymerizing the anionic organic acrylate monomer in the additive manufacturing polyelectrolyte resin in response to subjecting the additive manufacturing polyelectrolyte resin to the polymerizing light, such that an anionic poly-acrylate electrolyte is formed from the anionic organic acrylate monomer;
complexing the cationic poly-ammonium electrolyte with the anionic poly-acrylate electrolyte; and
forming a (poly-ammonium)-(poly-acrylate) electrolyte complex in response to complexing the cationic poly-ammonium electrolyte with the anionic poly-acrylate electrolyte, such that the (poly-ammonium)-(poly-acrylate) electrolyte complex comprises the cationic poly-ammonium electrolyte, the anionic poly-acrylate electrolyte, and an ionic linkage between an ammonium group of the cationic poly-ammonium electrolyte and an acrylate group of the anionic poly-acrylate electrolyte to additively manufacture the additively manufactured article from the additive manufacturing polyelectrolyte resin, wherein the additively manufactured article comprises the (poly-ammonium)-(poly-acrylate) electrolyte complex.

13. The process of claim 12, wherein the chemical modifier is the ion dispersion solvent that comprises the organic reactive diluent, and the process further comprises reacting the organic reactive diluent with the anionic organic acrylate monomer.

14. The process of claim 12, further comprising:
heating the (poly-ammonium)-(poly-acrylate) electrolyte complex above a curing temperature of the (poly-ammonium)-(poly-acrylate) electrolyte complex; and
crosslinking the cationic poly-ammonium electrolyte with the anionic poly-acrylate electrolyte in response to heating the (poly-ammonium)-(poly-acrylate) electrolyte complex above the curing temperature, such that the ionic linkage is replaced by a covalent amide bond to form a amide crosslinked polymer.

15. The process of claim 12, wherein the process for additively manufacturing includes vat photopolymerization to form the (poly-ammonium)-(poly-acrylate) electrolyte complex.

16. The process of claim 12, further comprises disposing the additive manufacturing polyelectrolyte resin in a vat photopolymerization 3D printer.

17. The process of claim 16, further comprises subjecting the additive manufacturing polyelectrolyte resin in the vat photopolymerization 3D printer to patterned light exposure to polymerize the anionic organic acrylate monomer of the additive manufacturing polyelectrolyte resin.

18. The process of claim 17, further comprises moving the (poly-ammonium)-(poly-acrylate) electrolyte complex relative to the polymerizing light to polymerize more of the anionic organic acrylate monomer and to produce more of the (poly-ammonium)-(poly-acrylate) electrolyte complex, such that the additively manufactured article is three-dimensionally printed via photopolymerization of the anionic organic acrylate monomer in presence of the cationic poly-ammonium electrolyte.

19. The process of claim 18, wherein the additively manufactured article is a three-dimensionally print.

20. The process of claim 16, wherein the (poly-ammonium)-(poly-acrylate) electrolyte complex is insoluble in the ion dispersion solvent.

21. The process of claim 12, wherein the additively manufactured article comprising the (poly-ammonium)-(poly-acrylate) electrolyte complex is recyclable.

22. The process of claim 12, wherein the additively manufactured article comprising the (poly-ammonium)-(poly-acrylate) electrolyte complex is flame retardant.

23. The process of claim 12, wherein the additively manufactured article comprising the (poly-ammonium)-(poly-acrylate) electrolyte complex is biocompatible.
